(19) United States
(12) Patent Application Publication
(10) Pub. No.: US 2023/0272146 A1
(43) Pub. Date: Aug. 31, 2023

(54) MULTI-LAYER POROUS BLOCK COPOLYMER FILMS

(71) Applicant: TERAPORE TECHNOLOGIES, INC., South San Francisco, CA (US)

(72) Inventors: Rachel DORIN, South San Francisco, CA (US); Jack WILSON, South San Francisco, CA (US); Chris CROCK, South San Francisco, CA (US); Steve PEARL, South San Francisco, CA (US); Spencer ROBBINS, South San Francisco, CA (US)

(21) Appl. No.: 18/019,392

(22) PCT Filed: Aug. 5, 2021
(86) PCT No.: PCT/US2021/044820

§ 371 Date: Feb. 2, 2023

Related U.S. Application Data
(60) Provisional application No. 63/061,481, filed on Aug. 5, 2020.

(51) Int. Cl. C08F 297/04

(52) U.S. Cl. CPC C08F 297/046

(57) ABSTRACT

The present disclosure relates to methods of making multi-layered graded multiblock copolymer films; multi-layered graded multiblock copolymer films made by the disclosed methods; uses of the disclosed multi-layered graded multiblock copolymer films; and devices comprising the disclosed multi-layered graded multiblock copolymer films. An exemplary disclosed multi-layered graded multiblock copolymer film has at least three identifiable layers comprising a first porous “skin” layer formed on the surface of a substrate, a porous bulk layer formed on the first porous “skin” layer, and a second porous “skin” layer formed on the surface of the porous bulk layer. This abstract is intended as a scanning tool for purposes of searching in the particular art and is not intended to be limiting of the present disclosure.

### CROSS-REFERENCE TO RELATED APPLICATIONS

This application claims the benefit of U.S. Provisional Application No. 63/061,481, filed on Aug. 5, 2020, which is incorporated herein by reference in its entirety.

### BACKGROUND

Understanding and controlling the transport of chemical species at the nanoscale is important for the design of novel devices and systems capable of addressing several of the issues facing chemical separations, drug delivery, and molecular sensing. Many of these technologies will rely on a membrane or film with robust mechanical properties and well-controlled pore dimensions and chemistries. In order to advance the understanding and implementation of technologies that exploit transport phenomena at the nanoscale, it is essential to make significant progress towards the fabrication and characterization of next generation, high performance mesoporous materials.

Membranes based on diblock copolymer and triblock terpolymer self-assembly have been generated through bulk casting, but these materials suffer from low permeability due to relatively thick selective layers. Mesoporous films from diblock copolymers have been fabricated by spin coating onto solid substrates; however, this method requires long annealing times and the tedious transfer of a fragile film from the primary substrate to a secondary support membrane.

Mesoporous isoporous block copolymer materials are known and are useful due to their small, uniform pores. Combining an asymmetric structure with the mesoporous isoporous structure makes the materials very useful for high resolution, high flux separations wherein the mesoporous isoporous “skin” enables high resolution separations and the asymmetric structure enables high flux. The manufacturing of these materials, however, often results in macrovoids that are deemed undesirable. It is widely taught that macrovoids in membranes are undesirable as they cause mechanical weakness and can breach the skin, causing defects.

Moreover, membranes or films comprising a multi-layer graded structure comprising a first porous skin, a porous bulk layer, and a second porous skin have not been previously described. Membranes comprising the foregoing structure would provide certain advantages that are not accessible with conventional materials.

Despite advances in membrane research, there remains a need for mesoporous isoporous membranes and films that combine an asymmetric structure with the mesoporous isoporous structure yet having minimal macrovoids. These needs and other needs are satisfied by the present disclosure.

### SUMMARY

In accordance with the purpose(s) of the disclosure, as embodied and broadly described herein, the disclosure, in one aspect, relates to methods of making multi-layered graded multiblock copolymer films; multi-layered graded multiblock copolymer films made by the disclosed methods; uses of the disclosed multi-layered graded multiblock copolymer films, and devices comprising the disclosed multi-layered graded multiblock copolymer films. In a further aspect, the present disclosure relates to methods for making multi-layered graded multiblock copolymer (BCP) films having at least three identifiable layers, the disclosed films made by the disclosed methods having at least three identifiable layers, devices comprising the disclosed films having at least three identifiable layers and uses of the disclosed films having at least three identifiable layers. An exemplary disclosed multi-layered graded multiblock copolymer film having at least three identifiable layers comprises a first porous “skin” layer formed on the surface of a substrate, a porous bulk layer formed on the first porous “skin” layer, and a second porous “skin” layer formed on the surface of the porous bulk layer.

Disclosed herein are multi-layer block copolymer materials, the multi-layer block copolymer materials comprising a self-assembled block copolymer; wherein the self-assembled block copolymer comprises: a first skin layer; a second skin layer; and a bulk layer disposed between the first skin layer and the second skin layer; and wherein each of the first skin layer, the second skin layer and the bulk layer comprise pores.

In a further aspect, disclosed herein are filtration devices comprising the disclosed multi-layer block copolymer materials.

In a further aspect, disclosed herein are methods of filtration wherein the method comprises providing a sample to a disclosed filtration device via an inlet to the disclosed filtration device; and collecting a filtrate material that has passed through the filtration device.

In a further aspect, disclosed herein are multi-layer block copolymer materials made by the disclosed methods.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic illustration of the procedure for forming a multi-layer graded BCP film in accordance with various aspects of the disclosure.

FIG. 2 is a schematic of an embodiment in accordance with various aspects of the present disclosure, wherein a fluid comprising solid particles is purified by contact with a multi-layer graded block copolymer (BCP) film.

FIG. 3 is a schematic of another embodiment in accordance with various aspects of the present disclosure, wherein a fluid comprising solid particles is purified by contact with a multi-layer graded block copolymer (BCP) film material wherein the liquid is pressurized.

FIG. 4 is a schematic of yet another embodiment in accordance with various aspects of the present disclosure, wherein a fluid comprising solid particles is purified by contact with a multi-layer graded block copolymer (BCP) film wherein vacuum is applied to the multi-layer graded block copolymer (BCP) film.

FIG. 5 is a schematic of yet another embodiment in accordance with various aspects of the present disclosure, wherein a fluid comprising solid particles is purified once by contact with a mesoporous isoporous block copolymer material, then said purified fluid is purified a second time by contact with a second multi-layer graded block copolymer (BCP) film.

FIG. 6 is a schematic of yet another embodiment in accordance with various aspects of the present disclosure, wherein a fluid comprising solid particles is purified once by contact with a multi-layer graded block copolymer (BCP) film wherein the liquid is pressurized, then said fractionated liquid is purified a second time by contact with a second multi-layer graded block copolymer (BCP) film.

FIG. 7 is a schematic of yet another embodiment in accordance with various aspects of the present disclosure, wherein fluid comprising solid particles is purified once by contact with a multi-layer graded block copolymer (BCP) film, then said purified fluid is purified a second time by contact with a second multi-layer graded block copolymer (BCP) film material wherein vacuum is applied at or near the outlet of the second multi-layer graded block copolymer (BCP) film providing a pressure differential across both membranes.

FIG. 8 is a schematic of yet another embodiment in accordance with various aspects of the present disclosure, wherein a fluid comprising solid particles is purified once by contact with a multi-layer graded block copolymer (BCP) film in crossflow mode, then the permeate is purified a second time by contact with a second multi-layer graded block copolymer (BCP) film in crossflow mode.

FIG. 9 is a schematic of yet another embodiment in accordance with various aspects of the present disclosure, wherein a fluid comprising solid particles is purified once by contact with a multi-layer graded block copolymer (BCP) film in crossflow mode, then the retentate is purified by contact with a second multi-layer graded block copolymer (BCP) film in crossflow mode.

FIG. 10 is an illustration of an exemplary device in accordance with various aspects of the present disclosure.

FIG. 11 is an illustration of another exemplary device in accordance with various aspects of the present disclosure.

FIG. 12 is an illustration of yet another exemplary device in accordance with various aspects of the present disclosure.

FIG. 13 is an illustration of yet another exemplary device in accordance with various aspects of the present disclosure.

FIG. 14 is an illustration of yet another exemplary device in accordance with various aspects of the present disclosure.

FIG. 15 is an illustration of yet another exemplary device in accordance with various aspects of the present disclosure.

FIG. 16 is an illustration of yet another exemplary device in accordance with various aspects of the present disclosure.

FIG. 17 is an illustration of yet another exemplary device in accordance with various aspects of the present disclosure.

FIG. 18 is an illustration of yet another exemplary device in accordance with various aspects of the present disclosure.

FIG. 19 is an illustration of yet another exemplary device in accordance with various aspects of the present disclosure.

FIG. 20 is an SEM image of an isoporous surface, or “skin,” layer of a multi-layer graded block copolymer (BCP) film formed in accordance with various aspects of the disclosure.

FIG. 21 is a cross-sectional scanning electron microscope (SEM) image of a BCP film formed in accordance with various aspects of the disclosure.

FIG. 22 is a cross-sectional SEM image of a multi-layer graded block copolymer (BCP) film formed on a nylon substrate (or support), where the BCP film, as shown in the figure, exhibits a second skin layer disposed on an external surface, a first skin layer adjacent to the nylon substrate, and a bulk layer therebetween, and 70 nm gold nanoparticles (AuNPs) disposed within the first skin layer and/or at an interface (also referred to herein as a “transition layer” or “interfacial layer”) between the first skin layer and the nylon substrate.

FIG. 23 is a cross-sectional SEM image of a multi-layer graded block copolymer (BCP) film formed on a nylon substrate (or support), where the BCP film, as shown in the figure, exhibits a second skin layer disposed on an external surface, a first skin layer adjacent to the nylon substrate, and a bulk layer therebetween, and and 50 nm AuNPs disposed within the first skin layer and/or at an interface between the first skin layer and the nylon substrate.

FIG. 24 is a cross-sectional SEM image of a multi-layer graded block copolymer (BCP) film formed on a nylon substrate (or support), where the BCP film, as shown in the figure, exhibits a second skin layer disposed on an external surface, a first skin layer adjacent to the nylon substrate, and a bulk layer therebetween, and 40 nm AuNPs disposed within the first skin layer and/or at an interface between the first skin layer and the nylon substrate.

FIG. 25 is a cross-sectional SEM image of a multi-layer graded block copolymer (BCP) film formed on a nylon substrate (or support), where the BCP film, as shown in the figure, exhibits a second skin layer disposed on an external surface, a first skin layer adjacent to the nylon substrate, and a bulk layer therebetween, and 30 nm AuNPs disposed within the first skin layer and/or at an interface between the first skin layer and the nylon substrate.

FIG. 26 is a cross-sectional SEM image of a multi-layer graded block copolymer (BCP) film formed on a nylon substrate (or support), where the BCP film, as shown in the figure, exhibits a second skin layer disposed on an external surface, a first skin layer adjacent to the nylon substrate, and a bulk layer therebetween, and 20 nm AuNPs disposed within the first skin layer and/or at an interface between the first skin layer and the nylon substrate, and 20 nm AuNPs disposed within the second skin layer and/or at an interface between the second skin layer and the bulk layer.

FIG. 27 is a cross-sectional SEM image of a multi-layer graded block copolymer (BCP) film formed on a nylon substrate (or support), where the BCP film, as shown in the figure, exhibits a second skin layer disposed on an external surface, a first skin layer adjacent to the nylon substrate, and a bulk layer therebetween, and 15 nm AuNPs disposed within the first skin layer and/or at an interface between the first skin layer and the nylon substrate, and 15 nm AuNPs disposed within the second skin layer and/or at an interface between the second skin layer and the bulk layer.

FIG. 28 is a cross-sectional SEM image of a multi-layer graded block copolymer (BCP) film formed on a nylon substrate (or support), where the BCP film, as shown in the figure, exhibits a second skin layer disposed on an external surface, a first skin layer adjacent to the nylon substrate, and a bulk layer therebetween, and 10 nm AuNPs disposed within the second skin layer and/or at an interface between the second skin layer and the bulk layer; and

FIG. 29 is a cross-sectional SEM image of a multi-layer graded block copolymer (BCP) film formed on a nylon substrate (or support), where the BCP film, as shown in the figure, exhibits a second skin layer disposed on an external surface, a first skin layer adjacent to the nylon substrate, and a bulk layer therebetween, and 5 nm AuNPs disposed within the second skin layer and/or at an interface between the second skin layer and the bulk layer.

FIG. 30 is a cross-sectional SEM image of a multi-layer graded block copolymer (BCP) film formed on a nylon substrate (or support), where the BCP film, as shown in the figure, showing in magnification a second skin layer disposed on an external surface and a bulk layer thereunder, and 40 nm AuNPs disposed within an interface between the external skin layer and the bulk layer.

FIG. 31 is a cross-sectional SEM image of a multi-layer graded block copolymer (BCP) film formed on a nylon substrate (or support), where the BCP film, as shown in the figure, showing in magnification a second skin layer disposed on an external surface and a bulk layer thereunder, and 40 nm AuNPs disposed within the external skin layer.

FIG. 32 is a cross-sectional SEM image of a multi-layer graded block copolymer (BCP) film formed on a nylon substrate (or support), where the BCP film, as shown in the figure, exhibits a second skin layer disposed on an external surface, a first skin layer adjacent to the nylon substrate, and a bulk layer therebetween, and 60 nm AuNPs disposed within the first skin layer and potentially at an interface between the first skin layer and the bulk layer.

FIG. 33 is a cross-sectional SEM image of a mufti-layer graded block copolymer (BCP) film formed on a nylon substrate (or support), where the BCP film, as shown in the figure, exhibits a second skin layer disposed on an external surface, a first skin layer adjacent to the nylon substrate, and a bulk layer therebetween, and 40 nm AuNPs disposed within the first skin layer and/or at an interface between the first skin layer and the bulk layer.

FIG. 34 is a cross-sectional SEM image of a multi-layer graded block copolymer (BCP) film formed on a nylon substrate (or support), where the BCP film, as shown in the figure, shows in magnification a second skin layer disposed on an external surface and a bulk layer thereunder and 40 nm AuNPs disposed within the second skin layer.

FIG. 35 is a cross-sectional SEM image of a multi-layer graded block copolymer (BCP) film formed on a nylon substrate (or support), where the BCP film, as shown in the figure, exhibits a second skin layer disposed on an external surface, a first skin layer adjacent to the nylon substrate, and a bulk layer therebetween, and 60 nm AuNPs disposed within the first skin layer and potentially at an interface between the first skin layer and the bulk layer.

FIG. 36 is a cross-sectional SEM image of a multi-layer graded block copolymer (BCP) film formed on a nylon substrate (or support), where the BCP film, as shown in the figure, exhibits a second skin layer disposed on an external surface and a bulk layer thereunder, and 60 nm AuNPs disposed within the second skin layer and within an interfacial layer between the second skin layer and the bulk layer.

FIG. 37 shows a cross-sectional schematic representation of a representative disclosed multi-layer block copolymer material comprising a self-assembled block copolymer comprising a first skin layer (2010); a second skin layer (2030); a bulk layer (2020) disposed between the first skin layer and the second skin layer; and a substrate (2040) disposed on a side of the second skin layer opposite the bulk layer.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other aspects disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### A. Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used herein, the term “and/or” includes any and all combinations of one or more of the associated listed items. Expressions such as “at least one of,” when preceding a list of elements, modify the entire list of elements and do not modify the individual elements of the list.

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

Reference to “a” chemical compound refers to one or more molecules of the chemical compound rather than being limited to a single molecule of the chemical compound. Furthermore, the one or more molecules may or may not be identical, so long as they fall under the category of the chemical compound. Thus, for example, “a” chemical compound is interpreted to include one or more molecules of the chemical, where the molecules may or may not be identical (e.g., different isotopic ratios, enantiomers, and the like).

As used in the specification and the appended claims, the singular forms “a,” “an” and “the” include plural referents unless the context clearly dictates otherwise. Thus, for example, reference to “a block copolymer,” “a substrate,” or “a pore,” includes, but is not limited to, two or more such block copolymers, substrates, or pores, and the like.

Reference to “a/an” chemical compound, polymer, protein, and antibody each refers to one or more molecules of the chemical compound, polymer, protein, and antibody rather than being limited to a single molecule of the chemical compound, polymer, protein, and antibody. Furthermore, the one or more molecules may or may not be identical, so long as they fall under the category of the chemical compound, protein, and antibody. Thus, for example, “an” antibody is interpreted to include one or more antibody molecules of the antibody, where the antibody molecules may or may not be identical, e.g., comprising different isotypes and/or different antigen binding sites as may be found in a polyclonal antibody. Another example to illustrate is “a” polymer is interpreted to include one or more polymer molecules of the polymer, where the polymer molecules may or may not be identical, e.g., comprising polymers of the described type but individual molecules having slightly different molecular weights such that the “polymer” can be characterized by a number average or weigh average molecular weight.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less' and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

As used herein, the terms “first porous skin layer”, “first skin layer”, and “first porous layer” can be used interchangeably and refer to the first skin layer as described herein below.

As used herein, the terms “second porous skin layer”, “second skin layer”, and “second porous layer” can be used interchangeably and refer to the second skin layer as described herein below.

As used herein, the term “micropore” means a pore having a pore diameter of about 0.2 nm to about 2 nanometers (nm). As used herein, a material which is referred as being “microporous” means a material that exhibits micropores. In some instances, materials according to the present disclosure can be as least partially microporous, with micropores located randomly throughout, or at specific locations within, the material.

As used herein, the term “mesopore” means a pore having a pore diameter of about 2 nm to about 50 nm. As used herein, a material which is referred as being “mesoporous” means a material that exhibits mesopores. In some instances, materials according to the present disclosure can be as least partially mesoporous, with mesopores located randomly throughout, or at specific locations within, the material.

As used herein, the term “macropore” means a pore having a pore diameter of about 50 nm to about 1000 nm (or 1 micrometer (μm)). As used herein, a material which is referred as being “macroporous” means a material that exhibits macropores. In some instances, materials according to the present disclosure can be as least partially macroporous, with macropores located randomly throughout, or at specific locations within, the material.

As used herein, the term “super-macropore” means a pore having a pore diameter of about 1 μm to about 20 μm. As used herein, a material which is referred as being “super-macroporous” means a material that exhibits super-macropores. In some instances, materials according to the present disclosure can be as least partially macroporous, with macropores located randomly throughout, or at specific locations within, the material. In some instances, super-macropores may also be referred to as macrovoids. The term “macrovoids” refers to large voids, the smallest of which can be super-macropores.

### B. Block Copolymers (BCPs)

In one aspect, the present disclosure relates to materials, devices, and methods comprising block copolymers as disclosed herein. Block copolymers, alternatively called multiblock polymers or multiblock copolymers, are defined as polymeric materials that comprise at least two covalently bonded “blocks” wherein each “block” is a polymer segment with a distinct constituent repeat unit, which may comprise a pattern of multiple types of atoms, for example a multiatomic “monomer” unit. For example, a multiblock polymer could comprise repeating units “A” and “B” which correlate to . . . -A-A-A- . . . and . . . -B-B-B- . . . blocks, respectively, wherein hyphens represent covalent bonds and the ellipses represent a repeating pattern of finite length; each block composed of repeat units could alternatively be denoted [A] and [B], respectively. In one instance, a diblock copolymer comprising only two blocks, [A] and [B] could be represented as [A]-[B]. In some instances, a multiblock polymer may contain more than one non-adjacent block comprised of the same constituent repeat unit, for example [A]-[B]-[A] is a triblock copolymer where the endblocks comprise the same repeat unit “A”. Another instance of a triblock copolymer comprises three distinct repeat units, A, B, and C, and the copolymer is of the form [A]-[B][C]. Other variations with more repeat units or alternate configurations can also exist, such as [A]-[B]-[A]-[C], [A]-[B]-[C]-[D], [A]-[B]-[C]-[D]-[B], and so forth. Some multiblock polymers can self-assemble into ordered nanoscale morphologies. This self-assembly behavior of multiblock polymers derives from the immiscibility of different blocks, causing demixing under certain processing conditions. Due to the covalent bonds between blocks and the nanoscale size of the block copolymer segments, the blocks can only phase separate into regions of extent of size comparable to the size of the blocks or the macromolecules containing the blocks rather than a macroscopic/bulk demixing. As is well known to those skilled in the art, such small-scale separation is generally known as nanophase separation. This nanophase separation, coupled with the well-defined structure of the block copolymers, can be utilized to generate well-defined nanoscale features.

In various embodiments, the multiblock copolymer is a triblock terpolymer having a structure of the form A-B-C, or A-C-B, or other variable arrangements or containing blocks of different chemical composition. In other embodiments, additional structures are higher order multiblock copolymer systems of the form A-B-C-B, or A-B-C-D, or A-B-C-B-A, or A-B-C-D-E, or other variable arrangements of these higher order systems. The multiblock copolymers can be synthesized by methods known in the art. For example, the copolymers can be synthesized using anionic polymerization, atom transfer radical polymerization (ATRP), or other suitable polymerization techniques. The multiblock copolymers can be also be obtained commercially.

The individual polymer blocks of multiblock copolymers useful in the disclosure can have broad molecular weight ranges. For example, blocks having a number averaged molecular weight (Mn) of from 1×10³ to 1×10⁶ g/mol, including all values to the 10 g/mol and ranges therebetween, can be used.

In some instances, multiblock copolymers used in accordance with the various aspects of the disclosure have at least one hydrogen-bonding block. The hydrogen-bonding block can self-assemble with another structurally distinct polymer block of the multiblock copolymer (e.g., a hydrophobic block). The hydrogen-bonding block has an acceptor group or donor group that can participate in intramolecular hydrogen bonding. In some instances, the hydrogen-bonding block can be a hydrophilic block. Examples of suitable hydrogen-bonding blocks include poly((4-vinyl)pyridine), poly((2-vinyl) pyridine), poly(ethylene oxide), poly(methacrylates) such as poly(methacrylate), poly(methyl methacrylate), and poly((dimethylamino)ethyl methacrylate), poly(acrylic acid), and poly(hydroxystyrene).

In some instances, multiblock copolymers used in accordance with the various aspects of the disclosure have a hydrophobic block. In some instances, multiblock copolymers used in accordance with the various aspects of the disclosure can have multiple hydrophobic blocks. Examples of suitable hydrophobic blocks include poly(styrenes), such as poly(styrene) and poly(alpha-methyl styrene), polyethylene, polypropylene, polyvinyl chloride, and polytetrafluoroethylene.

In some instances, multiblock copolymers used in accordance with the various aspects of the disclosure have a hydrophobic low glass transition temperature (T_{g}) block. By low T_{g} block it is meant that the block has a T_{g} of about 25° C. or less. The multiblock copolymer can have multiple low T_{g} blocks. Examples of suitable low T_{q} blocks include, but are not limited to, poly(isoprene), poly(butadiene), poly(butylene), and poly(isobutylene).

In some instances, multiblock copolymers used in accordance with the various aspects of the disclosure have at least one hydrogen-bonding block and at least one a hydrophobic block. In some instances, multiblock copolymers used in accordance with the various aspects of the disclosure have at least one hydrogen-bonding block and at lease one hydrophobic low glass transition temperature (T_{g}) block. In some instances, multiblock copolymers used in accordance with the various aspects of the disclosure have at least one of each of a hydrogen-bonding block, a hydrophobic block, and a hydrophobic low glass transition temperature (T_{g}) block.

Examples of suitable diblock copolymers include b-poly(styrene)-b-poly((4-vinyl)pyridine), poly(styrene)-b-poly((2-vinyl)pyridine), poly(styrene)-b-poly(ethyleneoxide), poly(styrene)-b-poly(methyl methacrylate), poly(styrene)-b-poly(acrylic acid), poly(styrene)-b-poly((dimethylamino)ethyl methacrylate), poly(styrene)-b-poly(hydroxystyrene), poly(α-methyl styrene)-b-poly((4-vinyl)pyridine), poly(α-methyl styrene)-b-poly((2-vinyl)pyridine), poly(α-methyl styrene)-b-poly(ethylene oxide), poly(α-methyl styrene)-b-poly(methyl methacrylate), poly(α-methyl styrene)-b-poly(acrylic acid), poly(α-methyl styrene)-b-poly((dimethylamino)ethyl methacrylate), poly (α-methyl styrene)-b-poly(hydroxystyrene), poly(isoprene)-b-poly((4-vinyl)pyridine), poly(isoprene)-b-poly((2-vinyl)pyridine), poly(isoprene)-b-poly(ethylene oxide), poly(isoprene)-b-poly(methyl methacrylate), poly(isoprene)-b-poly(acrylic acid), poly(isoprene)-b-poly((dimethylamino)ethyl methacrylate), poly(isoprene)-b-poly(hydroxystyrene), poly(butadiene)-b-poly((4-vinyl)pyridine), poly(butadiene)-b-poly((2-vinyl)pyridine), poly(butadiene)-b-poly(ethylene oxide), poly(butadiene)-b-poly(methylmethacrylate), poly(butadiene)-b-poly(acrylic acid), poly(butadiene)-b-poly((dimethylamino)ethyl methacrylate), and poly(butadiene)-b-poly(hydroxystyrene).

Examples of suitable triblock copolymers include poly(isoprene-b-styrene-b-4-vinylpyridine), poly(isoprene)-b-poly(styrene)-b-poly((4-vinyl)pyridine), poly(isoprene)-b-poly(styrene)-b-poly((2-vinyl)pyridine), poly(isoprene)-b-poly(styrene)-b-poly(ethylene oxide), poly(isoprene)-b-poly(styrene)-b-poly(methyl methacrylate), poly(isoprene)-b-poly(styrene)-b-poly(acrylic acid), poly(isoprene)-b-poly(styrene)-b-poly((dimethylamino)ethyl methacrylate), poly(isoprene)-b-poly(styrene)-b-poly(hydroxystyrene), poly(isoprene)-b-poly(α-methyl styrene)-b-poly((4-vinyl)pyridine), poly(isoprene)-b-poly(α-methyl styrene)-b-poly((2-vinyl)pyridine), poly(isoprene)-b-poly(α-methyl styrene)-b-poly(ethylene oxide), poly(isoprene)-b-poly(α-methyl styrene)-b-poly(methyl methacrylate), poly(isoprene)-b-poly(α-methyl styrene)-b-poly(acrylic acid), poly(isoprene)-b-poly(α-methyl styrene)-b-poly((dimethylethylamino)ethyl methacrylate), poly(butadiene)-b-poly(styrene)-b-poly((4-vinyl)pyridine), poly(butadiene)-b-poly(styrene)-b-poly((2-vinyl)pyridine), poly(butadiene)-b-poly(styrene)-b-poly(ethylene oxide), poly(butadiene)-b-poly(styrene)-b-poly(methyl methacrylate), poly(butadiene)-b-poly(styrene)-b-poly(acrylic acid), poly(butadiene)-b-poly(styrene)-b-poly(dimethylethyl amino ethyl methacrylate), poly(butadiene)-b-poly(styrene)-b-poly(hydroxystyrene), poly(butadiene)-b-poly(α-methyl styrene)-b-poly((4-vinyl)pyridine), poly(butadiene)-b-poly(α-methyl styrene)-b-poly((2-vinyl)pyridine), poly(butadiene)-b-poly(α-methyl styrene)-b-poly(ethylene oxide), poly(butadiene)-b-poly(α-methyl styrene)-b-poly(methyl methacrylate), poly(butadiene)-b-poly(α-methyl styrene)-b-poly(acrylic acid), poly(butadiene)-b-poly(α-methyl styrene)-b-poly((dimethylethylamino)ethyl methacrylate), and poly(butadiene)-b-poly(styrene)-b-poly(hydroxystyrene).

The total molar mass of the multiblock copolymer, or each multiblock copolymer, is such that the multiblock copolymer undergoes self-assembly (i.e., microphase separation) to form the multi-layer graded BCP films as described herein. In some instances, multiblock copolymers having a total molar mass of about 5×10³ to 5×10⁵ g/mol, including all values to the 10 g/mol and ranges therebetween, is preferred.

Multiblock copolymers can have a range of polydispersities (M_{w}/Mₙ). For example, the multiblock copolymer can have a polydispersity index (PDI) of from 1.0 to 2.0, including all values to the 0.1 and ranges therebetween. It is desirable that the multiblock copolymer have a PDI of 1 to 1.4.

Any homopolymer that has the same chemical composition as, or can hydrogen bond to, at least one block (e.g., the hydrogen-bonding block) of the multiblock copolymer can be used. The homopolymer can have hydrogen bond donors or hydrogen bond acceptors. Examples of suitable homopolymers include, but are not limited to, polyvinylpyrrolidone (PVP), poly((4-vinyl)pyridine), poly(acrylic acid), and poly(hydroxy styrene). It is desirable that the homopolymers or small molecules have a low or negative chi parameter with the hydrogen-bonding block (e.g., poly((4-vinyl)pyridine)). A range of ratios of multiblock copolymer to homopolymer can be used. For example, the molar ratio of multiblock copolymer to homopolymer can be from 1:0.05 to 1:10, including all ranges therebetween. The homopolymer can have a range of molecular weight. For example, the homopolymer can have a molecular weight of from 5×10² g/mol to 5×10⁴ g/mol. In some instances, PVP having a molecular weight ranging from about 1,000 g/mol to about 1,000,000 g/mol can be used.

Any small molecule that can hydrogen bond to at least one block of the multiblock copolymer can be used. The small molecule can have hydrogen bond donors or hydrogen bond acceptors. Examples of suitable small molecules include, but are not limited to, glycerol, ethylene glycol (EG), triethylene glycol (TEG), propylene glycol (PG), pentadecyl phenol, dodecyl phenol, 2-4′-(hydroxybenzeneazo)benzoic acid (HABA), 1,8-naphthalene-dimethanol, 3-hydroxy-2-naphthoic acid, and 6-hydroxy-2-naphthoic acid. A range of ratios of multiblock copolymer to small molecule can be used. For example, the molar ratio of multiblock copolymer to small molecule can be from 1:1 to 1:1000, including all integer ratios therebetween.

### C. Block Copolymer (BCP) Films

In one aspect, the present disclosure relates to multi-layer block copolymer materials, the multi-layer block copolymer materials comprising a self-assembled block copolymer; wherein the self-assembled block copolymer comprises: a first skin layer; a second skin layer; and a bulk layer disposed between the first skin layer and the second skin layer; and wherein each of the first skin layer, the second skin layer and the bulk layer comprise pores. A variety of multiblock copolymers can be used to fabricate multi-layer graded BCP films according to the disclosure. For example, suitable multiblock copolymers can be diblock copolymers, triblock copolymers, or higher order multiblock copolymers as described herein above. In a further aspect, the multi-layer graded block copolymer (BCP) materials are asymmetric. In a still further aspect, multi-layer graded block copolymer (BCP) films are graded.

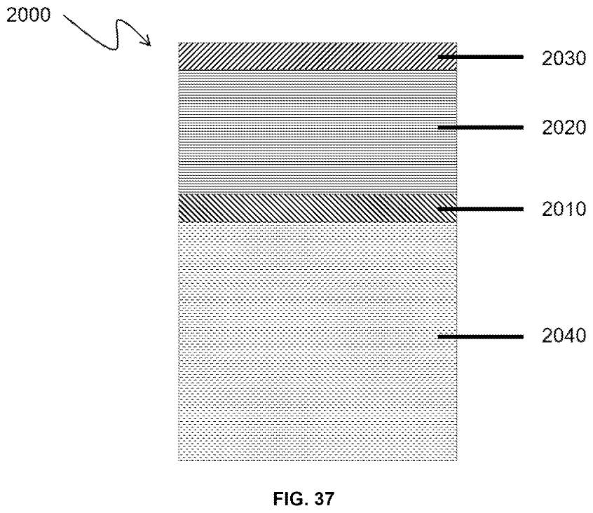

FIG. 37 shows a cross-sectional schematic representation of a representative disclosed multi-layer block copolymer material comprising a self-assembled block copolymer comprising a first skin layer (2010); a second skin layer (2030); a bulk layer (2020) disposed between the first skin layer and the second skin layer; and a substrate (2040) disposed on a side of the second skin layer opposite the bulk layer.

In some instances, multi-layer block copolymer (BCP) films according to the disclosure can be crosslinked. As used herein, a “crosslink” means a covalent linkage between two or more distinct polymer chains. Being “crosslinked” is defined as having a region of material where two or more distinct polymer chains are covalently linked directly or indirectly to each other. The physical and chemical properties of the material and the performance as a separation medium are affected by the nature of the crosslinking. For example, the degree of crosslinking, chemistry of crosslinker, and method of crosslinking all affect the physical and chemical properties of the final material. Crosslinking necessarily affects and changes the covalent bonding of at least one of the blocks of a multiblock copolymer. As a result of these covalent changes to the bonding upon crosslinking, it is understood that not all of the repeat units in a given block will be identical, as crosslinked repeat units will have different covalent bonds than corresponding uncrosslinked repeat units.

In some instances, multi-layer block copolymer (BCP) films according to the disclosure can be neutrally charged. As used herein, the phrase “neutrally charged” means lacking significant surface charge around neutral pH (pH=7). Lacking a significant surface charge is defined as having a zeta potential absolute value of 30 mV or less; more specifically, |zeta potential|≤30 mV. In some embodiments, the absolute value of the zeta potential is around 25 mV or less. In some embodiments, the absolute value of the zeta potential is around 20 mV or less. In some embodiments, the absolute value of the zeta potential is around 15 mV or less. In some embodiments, the absolute value of the zeta potential is around 10 mV or less. In some embodiments, the absolute value of the zeta potential is around 5 mV or less. In some embodiments, the absolute value of the zeta potential is around 0 mV. One method for determining the zeta potential of the porous materials is measuring its streaming zeta potential at a given pH. This method, as is well known to those skilled in the art, allows for measuring the zeta potential of solid-state polymeric materials such as porous films. A small area of the film is mounted in a film sample holder and an electrolyte solution (for example, 0.001 M KCl at pH 7, or another pH of interest) is flowed over the sample while the zeta potential is measured and is typically reported in mV.

Any reactive cross-linkable chemistry is suitable for the porous block copolymer material prior to crosslinking. It is understood that crosslinked materials are not typically processable as they are essentially macroscopic molecules that are typically insoluble and not thermally processable; the self-assembly into the porous material occurs first and is then surface crosslinked after structure formation. Any block copolymer chemistry amenable to surface crosslinking and, optionally, amenable to the formation of a neutrally charged surface on the resulting porous block copolymer material is suitable. After processing into a porous material, at least a portion of at least one block near the void/material interface should be amenable to surface crosslinking. To be suitable for crosslinking, at least a portion of at least one surface block should bear a chemical functional group capable of reacting with a crosslinker's functional group. It is understood that crosslinking moieties may be chemically multifunctional, and can vary in length and size.

Some non-exhaustive examples of suitable chemistries which can be reacted on either the porous material or on a crosslinker include: carboxylic acid groups, hydroxyl groups, alkyne groups, amine groups, other carbonyl-containing groups (such as amides), epoxides, double bonds, triple bonds, azide groups, thiol groups, nitrile groups, disulfide groups, anhydride groups, and imine groups, etc. Any combination which results in a neutrally charged surface is suitable. Some non-exhaustive examples of suitable combinations of reactive groups or reaction types include: amines combined with epoxides to form a C—N or C—C bond therebetween; alkynes combined with azides to form C—N bonds therebetween; hydroxyl groups combined with halides to form a C—O bond therebetween; conjugated dienes and substituted alkenes to form a C—C bonds therebetween; nitrile groups with halides to form a C—N bond therebetween; nitrile groups with Grignard reagents to form a X bond therebetween; methoxides with halides to form a C—C bond therebetween; epoxides with alcohols to form a C—O bond therebetween; epoxides with Grignard reagents to form a C—C bond therebetween; epoxides with alkoxides to form a C—O bond therebetween; thiols with alkenes to form a C—S bond therebetween; thiols with alkynes to form a C—S bond therebetween; sulfides with sulfides to form a S—S bond therebetween; episulfides with amines to form a C—N bond therebetween; episulfide with epoxides to form a C—C bond therebetween; carboxylic acids with alcohols to form a C—O bond therebetween; carboxylic acids with 1-ethyl-3-(3-dimethylaminopropyl)carbodiimide (EDC) moieties to form a C—N bond therebetween; carboxylic acids with amines to form a C—N bond therebetween; carboxylic acids with acid chlorides to form C—O bonds therebetween; carboxylic acids with thiols to form a C—S bond therebetween.

In some instances, multi-layer block copolymer (BCP) films according to the disclosure can be surface crosslinked. As used herein, the phrase “surface crosslinked” means having crosslinked functionality observable within some or all of a 2 μm depth/distance inward from any porous material surface. In some instances, the “surface” of the material is not limited to the top, bottom, and sides of the material macroscopically. “Inward” means moving in towards a center of the material. For example, a porous inventive material may macroscopically be a film with a thickness on the order of hundreds of micrometers and a diameter or length and/or width on the order of centimeters; the “surface” of the material may extend through the depth of the film since pores of varying size can extend from one side of the film to the other (e.g., top to bottom). In some instances, some regions of the material are not 2 μm thick, for example a material's wall separating two 10 nm pores (perpendicular to the cylindrical pore center) may be on the order of nanometers; however, the wall may extend parallel to the cylindrical pore center more than 2 μm. One example of a method of probing/observing surface crosslinking is Fourier Transform Infrared Attenuated Total Reflection Spectroscopy (FTIR-ATR). FTIR-ATR is a surface analysis technique notable for identification of functional groups up to 2 microns deep into solid-state materials. FTIR-ATR can identify crosslinked moieties in surface crosslinked materials by the presence or absence of characteristic peaks resulting from covalent and non-covalent changes in the bonding of the porous materials. One example of an FTIR signal change upon surface crosslinking is the appearance of a distinct peak or functional group present in the crosslinking moiety. Another example of an FTIR signal change upon crosslinking is the disappearance of a functional group peak on the porous material upon reaction with a crosslinker. Another example of an FTIR signal change upon surface crosslinking is a combination of the appearance of a new peak from a crosslinking moiety as well as a disappearance of a peak from a porous material. All three types of signal changes, or more, may be observed in an FTIR spectrum after a crosslinking reaction has been performed.

In the context of the disclosure, a “crosslinking moiety” is the resulting chemical structural comprising the linkage (crosslink) between distinct chains. The chemical and physical properties of the crosslinking moiety or moieties are determined largely by the chemical structure of the moiety, which are a result of both the crosslinking agent (“crosslinker”) chemical structure and the resulting chemical structure from the reaction of the crosslinker with the block copolymer. It is understood that the reaction of crosslinker with block copolymer surface functional group(s) results in a covalent bond or covalent bonds and potentially chemical rearrangements which result in the crosslink/crosslinking moiety; these chemical structures influence the chemical and physical properties of the crosslinked material. In some embodiments, the crosslinking moiety is polymeric, for example a polyacrylate moiety. In some embodiments, the crosslinking moiety is a small molecule, for example a triol moiety. In some embodiments, the crosslinking moiety is hydrophilic, for example a carboxylic acid moiety. In some embodiments, the crosslinking moiety is hydrophobic, for example an alkyl chain moiety. In some embodiments the crosslinking moiety is fluorinated, for example a perfluorinated alkyl chain. In some instances, the crosslinking moiety can have a combination of properties. For example, the crosslinking moiety can be a hydrophilic polymeric moiety (such as polyethylene glycol chain) or a hydrophobic polymeric moiety (for example a polyolefin chain). In some instances, the polymeric moiety can be hydrophobic because it is fluorinated. The nature of the crosslinking moiety and its attachment to the block copolymer affect the performance and physical properties of the porous materials. For example, hydrophilic crosslinking moieties such as PEG chain moiety may impart hydrophilic character to the surface of the porous self-assembled multiblock polymer materials which would be useful for protein antifouling character in a biological fluid separation application. For example, hydrophobic crosslinking moieties such as alkyl chains may impart hydrophobic character to the surface of the porous materials which would be useful for wetting and thus increased flux of a hydrophobic solvent, like hexanes, during a filtration application.

Embodiments of the disclosure are directed to isoporous multi-layer block copolymer (BCP) films made from multiblock copolymers methods of making the isoporous graded multi-layer films from multiblock copolymers. In some instances, multi-layer graded BCP films according to the disclosure have at least three identifiable layers, the first identifiable layer is a first porous “skin” layer formed on the surface of the substrate, and the second identifiable layer is a porous bulk layer formed on the first porous “skin” layer. The third identifiable layer is a second porous “skin” layer formed on the surface of the porous bulk layer. Such multi-layer graded BCP films therefore exhibit a sandwich-type structure with a porous bulk layer situated between porous skin layers. Such multi-layer graded BCP films, having at least three identifiable layers, can be supported on a substrate or can be a free-standing film. While the film may have at least three identifiable layers, the film itself constitutes a continuous film structure where each layer is chemically and/or physically bonded to adjacent layers and the adjacent layers are at least partially interconnected by pores, allowing for the transmission of one or more fluids between adjacent layers. In some instances, at least one of the at least three identifiable layers is isoporous. In some instances, at least two of the at least three identifiable layers are isoporous. In some instances, at least the first porous “skin” layer is isoporous. In some instances, at least the second porous “skin” layer is isoporous. In some instances, both of the first and second porous “skin” layers are isoporous.

In some instances, multi-layer graded BCP films according to the disclosure have at least five identifiable layers. The first identifiable layer is a first porous “skin” layer formed on the surface of the substrate, the second identifiable layer is a porous bulk layer formed on the first porous “skin” layer, the third identifiable layer is a second porous “skin” layer formed on the surface of the porous bulk layer, the fourth identifiable layer is a first porous transition layer structure between the first skin layer and the bulk layer, and having physical and/or chemical characteristics of both the first skin layer and the bulk layer, and the fifth identifiable layer is a second porous transition layer structure between the second skin layer and the bulk layer, and having physical and/or chemical characteristics of both the second skin layer and the bulk layer. Such multi-layer graded BCP films therefore exhibit a sandwich-type structure with a porous bulk layer situated between porous skin layers and transition a layer between each of the first and second skin layers and the bulk layer. Such multi-layer graded films, having at least five identifiable layers, can be supported on a substrate or can be a free-standing film. While the film may have at least five identifiable layers, the film itself constitutes a continuous film structure where each layer is chemically and/or physically bonded to adjacent layers and the adjacent layers are at least partially interconnected by pores, allowing for the transmission of one or more fluids between adjacent layers. In some instances, at least one of the at least five identifiable layers is isoporous. In some instances, at least two of the at least five identifiable layers are isoporous. In some instances, at least the first porous “skin” layer is isoporous. In some instances, at least the second porous “skin” layer is isoporous. In some instances, both of the first and second porous “skin” layers are isoporous.

By “isoporous” it is meant that at least one surface layer of the multi-layer graded films have a narrow pore size distribution such that at least 75%, preferably at least 80%, more preferably at least 85%, and even more preferably at least 90% of the pores in the at least one surface layer exhibit diameters that are not more than 25% greater or less than, preferably not more than 20% greater or less than, more preferably not more than 20% greater or less than, and even more preferably not more than 20% greater or less than the average pore size of the pores of the at least one surface layer. By “graded” it is meant that the films have pore of varying average diameters as a function of depth. Isoporous graded films can be made by the methods disclosed herein. The films include at least a multiblock copolymer. The multiblock copolymer can be one of those described herein. The film can be disposed on a substrate or can be a free standing film.

Multi-layer graded BCP films according to the disclosure can have a variety of shapes. One of skill in the art will appreciate that films having a variety of shapes can be fabricated. The films can have a broad range of sizes (e.g., film thicknesses and film area). For example, the films can have a thickness of from 5 microns to 500 microns, including all values to the micron and ranges therebetween. Depending on the application (e.g., bench-top applications, biopharmaceutical applications, and water purification applications, the films can have areas ranging from 10 s of cm² to 10 s (even 100 s) of m². In some instances, multi-layer graded BCP films can be fabricated on substrates which are pre-cut to have a defined shape such as, for example, a circular or square wafer having a dimensions suitable for placement within a circular filtration tube or a rectangular filtration cassette. In some instances, multi-layer graded BCP films can be fabricated on a continuous roll or sheet of a substrate, and the resulting substrate-supported multi-layer graded BCP films can later be cut to have a desired shape for any suitable application such as, for example, a circular or square substrate-supported multi-layer graded BCP filter membrane having a diameter suitable for placement within a circular filtration tube or a rectangular filtration cassette.

By careful choice of multiblock copolymer chemistry and film preparation conditions, multi-layer graded BCP films formed according to the disclosure can be fabricated to have various desirable properties. For example, the films can have desirable mechanical properties (for example, toughness and flexibility), permeabilities, size selective separation capabilities, pH-dependent separation capabilities. The structural and performance characteristics of the films can include both stimuli responsive permeation and separation. Multi-layer graded BCP films formed according to the disclosure can be tuned in a manner so that transport of various liquids and solids can be controlled. For example, the pore size of the films can be tuned (e.g., increased or decreased) by hybridization of the film by incorporating a homopolymer or a small molecule in the deposition solution or by exposing the film to a specific pH solution (e.g., the film is exposed a feed solution having a desired pH after the NIPS process).

Multi-layer graded BCP films according to the disclosure comprise two surface layers (also referred to herein as skin layers) indirectly or directly sandwiching a bulk layer. The surface layers can have a range of thicknesses. Each surface layer can have the same, substantially the same or different thicknesses relative to each other. Generally, each surface layer can individually have a thickness of from about 1 nm to about 1 μm, including all values to the nm and ranges therebetween. In some instances, each surface layer can individually have a thickness of from about 20 nm to about 500 nm. In some instances, each surface layer can individually have a thickness of from about 500 nm to about 1 μm. In some instances, each surface layer can individually have a thickness of from about 500 nm to about 2 μm. In some instances, each surface layer can individually have a thickness of from about 50 nm to about 1 μm. In some instances, each surface layer can individually have a thickness of from about 50 nm to about 900 nm. In some instances, each surface layer can individually have a thickness of from about 100 nm to about 900 nm. In some instances, each surface layer can individually have a thickness of from about 100 nm to about 800 nm. In some instances, each surface layer can individually have a thickness of from about 200 nm to about 800 nm. In some instances, each surface layer can individually have a thickness of from about 300 nm to about 800 nm. In some instances, each surface layer can individually have a thickness of from about 300 nm to about 700 nm. Each surface layer has a plurality of pores extending thorough the depth of the surface layer. The pores can have morphologies such as, but not limited to, cylindrical, worm-like, sponge-like and gyroid morphologies. The pores can have sizes (e.g., diameters) ranging from about 5 nm to about 100 nm, alternatively from about 5 nm to about 75 nm, alternatively from about 5 nm to about 50 nm, alternatively from about 5 nm to about 40 nm, alternatively from about 5 nm to about 40 nm, alternatively from about 5 nm to about 30 nm, and alternatively from about 5 nm to about 25 nm, including all values to the nm and ranges therebetween. Each surface layer can have a range of pore densities. For example, the surface layer pore density of one or both of the surface layers can be from about 1×10¹³ pores/m² to about 1×10¹⁵ pores/m², including all values to the 10 pores/m² and ranges therebetween. In some instances, the density of the surface pores of a BCP film as described herein is at least 10¹³ pores/m². In some instances, the surface layer pore density of one or both of the surface layers can be from about 5×10¹³ pores/m² to 5×10¹⁴ pores/m². In some instances, the surface layer pore density of one or both of the surface layers can be from about 5×10¹³ pores/m² to 1×10¹³ pores/m². In some instances, one or both of the surface layers are isoporous. In some instances, one or both surface layers exhibit vertically aligned and nearly monodisperse pores. In some instances, one or both surface layers exhibit a pore density of at least 1×³10 pores/m² and a pore size distribution (dₘₐₓ/dₘᵢₙ) of less than 3. In some instances, one or both surface layers exhibit a pore density of at least 1×10¹³ pores/m² and a pore size distribution (dₘₐₓ/dₘᵢₙ) of less than 2. In some instances, one or both surface layers exhibit a pore density of at least 1×10¹³ pores/m² and a pore size distribution (dₘₐₓ/dₘᵢₙ) of less than 1.5.

Multi-layer graded BCP films according to the disclosure can also be made with bulk layers of varying thicknesses and porosities. In some instances, the thickness of bulk layer can range from about 1 μm to about 100 μm. In other instances, the thickness of bulk layer can range from about 1 μm to about 80 μm, alternatively from about 1 μm to about 60 μm, alternatively from about 2 μm to about 50 μm, alternatively from about 2 μm to about 40 μm, alternatively from about 2 μm to about 30 μm, alternatively from about 2 μm to about 20 μm, alternatively from about 2 μm to about 15 μm, and alternatively from about 2 μm to about 10 μm. In some instances, the bulk layer exhibits an exclusively macroporous structure. In other instances, the bulk layer exhibits a structure which contains both mesopores and macropores. In yet other instances, the bulk layer exhibits a structure which contains both macropores and super-macropores. In yet other instances, the bulk layer exhibits a structure which contains a combination of mesopores, macropores and super-macropores. The pores of bulk layer can have morphologies such as, but not limited to, cylindrical, worm-like, sponge-like and gyroid morphologies.

In some instances, the bulk layer exhibits a graded structure wherein the average pore diameter increases from a first porous skin layer to a second porous skin layer. In such instances, the bulk layer can be characterized as having smallest pore diameters near or adjacent to the first porous skin layer and as having largest pore diameters near or adjacent to the second porous skin layer. In instances where there is a transition layer between the bulk layer and each of the first and second porous skin layers, the bulk layer can be characterized as having smallest pore diameters near or adjacent to the transition layer between the bulk layer and the first porous skin layer and as having largest pore diameters near or adjacent to the transition layer between the bulk layer and the second porous skin layer.

In some instances, the bulk layer exhibits a graded structure wherein the average pore diameter increases from a first porous skin layer to a certain depth, and then decreases from that depth to a second porous skin layer. In such instances, the bulk layer can be characterized as having smallest pore diameters near or adjacent to the first and second porous skin layers and as having largest pore diameters at the certain depth within the bulk layer. In instances where there is a transition layer between the bulk layer and each of the first and second porous skin layers, the bulk layer can be characterized as having smallest pore diameters near or adjacent to each transition layer and as having largest pore diameters at the certain depth within the bulk layer. In some instances, the depth at which the pore diameters in the bulk layer are the largest may be at or around the midpoint of the bulk layer. For example, if the bulk layer has an overall thickness of about 30 μm, the largest average pore diameters may be found at or around at depth of about 15 μm, alternatively at depths ranging from about 14.5 to about 15.5 μm, alternatively at depths ranging from about 14 to about 16 μm, alternatively at depths ranging from about 12.5 to about 17.5 μm, alternatively at depths ranging from about 12 to about 18 μm, and alternatively at depths ranging from about 10 to about 20 μm. In some instances, the depth at which the pore diameters are the largest may be at or around a location other than the midpoint of the bulk layer. For example, if the bulk layer has an overall thickness of about 30 μm, the largest average pore diameters may be found at or around depths of about 5 μm to about 14 μm, or about 16 to about 25 μm.

In various aspects, the second skin layer has average pore diameters less than an average pore diameter of the first skin layer. For example, the second layer can have average pore diameter that is less than the average pore diameter of the first skin layer by from about 5% to about 200%. In a further aspect, the average pore diameter of the second skin layer is at least about 5% less than average pore diameter of the first skin layer; at least about 10% less than average pore diameter of the first skin layer; is at least about 15% less than average pore diameter of the first skin layer; at least about 20% less than average pore diameter of the first skin layer; at least about 30% less than average pore diameter of the first skin layer; at least about 50% less than average pore diameter of the first skin layer; at least about 100% less than average pore diameter of the first skin layer; or at least about 150% less than average pore diameter of the first skin layer.

In various aspects, the pore diameter of the second skin layer is less than pore diameter of the bulk layer. It is understood that the comparison of the pore diameter of the second skin layer refers to the average pore diameter of the second skin layer, whereas the pore diameter of the bulk layer refers not to the mesopores that can be templated by the self-assembly of the BCPs, but rather to the larger, phase inverted pores in the bulk layer. In a further aspect, the average pore diameter of the second skin layer is at least about 10% less than the average pore diameter of the phase inverted pores of the bulk layer; about 50% less than the average pore diameter of the phase inverted pores of the bulk layer; about 100% less than the average pore diameter of the phase inverted pores of the bulk layer; about 250% less than the average pore diameter of the phase inverted pores of the bulk layer; about 500% less than the average pore diameter of the phase inverted pores of the bulk layer, about 750% less than the average pore diameter of the phase inverted pores of the bulk layer; or about 1000% less than the average pore diameter of the phase inverted pores of the bulk layer.

### D. Inorganic Materials

In some instances, multi-layer graded BCP films according to the present disclosure further includes an inorganic material. In some instances, the inorganic material is in the form of particulates and is disposed within pores of the film. In some instances, the particulates of inorganic material are nanoparticles having sizes that are approximately equal to or slightly less than the average pore diameters of the first porous skin layer such that the nanoparticles are contained within the pores of the first porous skin layer. In some instances, the particulates of inorganic material are nanoparticles having sizes that are approximately equal to or slightly less than the average pore diameters of the second porous skin layer such that the nanoparticles are contained within the pores of the second porous skin layer. In some instances, the particulates of inorganic material are nanoparticles having sizes that are approximately equal to or slightly less than the average pore diameters of both of the first and second porous skin layers such that the nanoparticles are contained within the pores of both of the first and second porous skin layers. In some instances, the nanoparticles are disposed with the pores of one or both of the first and second porous skin layers merely by physical entrapment. In some instances, the nanoparticles are disposed with the pores of one or both of the first and second porous skin layers by non-covalent binding between the nanoparticles and a polymer block of the BCP film such as, for example, electrostatic interactions or Van der Waals forces.

The inorganic material nanoparticles can be, for example, 1 to 200 nm, including all values to the nanometer and ranges therebetween, in diameter. In some instances, the inorganic material nanoparticles be made of a single metal such as, for example, Cu, Ag, Au, Pd, Pt, and Rh nanoparticles. In some instances, the inorganic material nanoparticles be made of a metal alloy such as Pt—Cu, Pt—Au, Pd—Au, Ag—Au, Co—Fe, Pt—Ru, Ag—Au—Cu—Pd—Pt, Ni—Fe, Pt—Mn, Pt—Fe, Pd—Fe, Ni—Cu, Cu₂MnAl, Cu₂MnIn, Cu₂MnSn, Ni₂MnAl, Ni₂MnIn, Ni₂MnSn, Ni₂MnSb, Ni₂MnGa, Co₂MnAl, Co₂MnSi, Co₂MnGa, Co₂MnGe, Co₂NiGa, Pd₂MnAl, Pd₂MnIn, Pd₂MnSn, Pd₂MnSb, Fe₂VAl Co₂FeSi, Co₂FeAl, Mn₂VGa, and Co₂FeGe. In some instances, the inorganic material nanoparticles be made of metal oxides such as silver oxide, copper oxide, vanadium oxide, zinc oxide, titanium dioxide, manganese oxide, tin oxide, iron oxide, cobalt oxide, cobalt oxide, nickel iron oxide, aluminum oxide, cerium oxide, molybdenum oxide, and yttrium oxide. In some instances, multi-layer graded BCP films can serve as an inert carrier for metal, metal alloy and metal oxide nanoparticles for use as a heterogeneous catalyst.

In some instances, the inorganic material nanoparticles can be made of core, core-shell or core-multishell semiconductor nanoparticles (also known as quantum dots) wherein the core and shell(s) can be made of IIA-VIA (2-16) materials (MgS, MgSe, MgTe, CaS, CaSe, CaTe, SrS, SrSe, SrTe, BaS, BaSe, BaTe), IIB-VIA (12-16) materials (ZnS, ZnSe, ZnTe, CdS, CdSe, CdTe, HgS, HgSe, HgTe), II-V materials (Zn₃P₂, Zn₃As₂, Cd₃P₂, Cd₃As₂, Cd₃N₂, Zn₃N₂), III-V materials (BP, AlP, AlAs, AlSb; GaN, GaP, GaAs, GaSb; InN, InP, InAs, InSb, AlN, BN, InGaP, AlInN, AlGaInN, InGaN, AlInP), III-IV materials (B₄C, Al₄C₃, Ga₄C), II-VI materials (Al₂S₃, Al₂Se₃, Al₂Te₃, Ga₂S₃, Ga₂Sea, GeTe; In₂S₃, In₂Se₃, Ga₂Te₃, In₂Te₃, InTe), V-VI materials (Bi₂Te₃, Bi₂Se₃, Sb₂Se₃, Sb₂Te₃) or I-III-VI materials (for example, CuInS₂, CuInSe₂, CuGaS₂, CuGaSe₂, CuInₓGa₁₋ₓS_{y}Se_{2-y} (where 0≤x≤1 and 0≤y≤2), AgInS₂) or any combination thereof. In some instances, the inorganic material nanoparticles can be made of inorganic phosphors such as lanthanide nanoparticle compounds. Lanthanide phosphors include but are not restricted to: Ce³⁺-doped phosphors, Eu²⁺-doped phosphors, Eu³⁺-doped phosphors, Pr³⁺-doped phosphors, Sm³⁺-doped phosphors; Tb³⁺-doped phosphors, Er³⁺-doped phosphors, Yb³⁺-doped phosphors, Nd³⁺-doped phosphors, Dy³⁺-doped phosphors. In some instances, multi-layer graded BCP films can serve as an inert carrier for semiconductor inorganic phosphor nanoparticles for use as heterogeneous photoluminescent films.

### E. Block Copolymers (BCPs) Film Substrates

In accordance with various aspects of the disclosure, multi-layer graded BCP films can be formed on a substrate. The chemical composition of the substrate is not particularly limiting. The inventors have surprisingly found, however, that the formation of multi-layer graded BCP films is at least partially controlled by the pore size of the substrate. Generally, substrates used in accordance with the disclosure should have average pore diameters ranging from about 0.1 μm to about 1 μm. In some instances, multi-layer graded BCP films can be formed by applying a BCP-containing solution onto substrates which are pre-cut to have a defined shape such as, for example, a circular or square wafer. In some instances, multi-layer graded BCP films can be formed by applying a BCP-containing solution onto a continuous roll or sheet of a substrate, and the resulting substrate-supported multi-layer graded BCP films can later be cut to have a desired shape for any suitable application.

In some instances, the substrate can be a aliphatic or semi-aromatic polyamide (commonly referred to as “nylon”). Exemplary commercially available Nylon substrates include filter membranes with 0.45 μm pore diameters (Sigma-Aldrich Cat. Nos. Z290815, Z290785, Z290793), 0.22 μm pore diameters (Sigma-Aldrich Cat. No. Z290807), and 0.2 μm pore diameters (Sigma-Aldrich Cat. Nos. Z290823, Z269476, 58060U).

In some instances, the substrate can be a cellulosic membrane. Exemplary commercially available cellulosic substrates include filter membranes with 1 μm pore diameters (Sigma-Aldrich Cat. Nos. WHA10410012, WHA10410014), 0.45 μm pore diameters (Sigma-Aldrich Cat. Nos. WHA10410312, WHA10410212, WHA10410214), 0.22 μm pore diameters (Sigma-Aldrich Cat. No. 58188), and 0.2 μm pore diameters (Sigma-Aldrich Cat. Nos. WHA10410319, WHA10410314, WHA10410312).

In some instances, the substrate can be a cellulose acetate membrane. Exemplary commercially available cellulose acetate substrates include filter membranes with 0.8 μm pore diameters (Sigma-Aldrich Cat. No. WHA10403112), 0.45 μm pore diameters (Sigma-Aldrich Cat. Nos. WHA10404031, WHA70000002, WHA70000004), and 0.2 μm pore diameters (Sigma-Aldrich Cat. Nos. WHA70010004, WHA10404106).

In some instances, the substrate can be a mixed cellulose ester membrane. Exemplary commercially available mixed cellulose ester substrates include filter membranes with 0.8 μm pore diameters (Sigma-Aldrich Cat. Nos. WHA10400912, WHA10400909, AAWP14250), 0.65 μm pore diameters (Sigma-Aldrich Cat. Nos. DAWP14250, DAWP09025), 0.45 μm pore diameters (Sigma-Aldrich Cat. Nos. WHA7141204, WHA7141154, DAWP01300), 0.3 μm pore diameters (Sigma-Aldrich Cat. Nos. PHWPO2500, PHWP14250, PHWP09025), 0.22 μm pore diameters (Sigma-Aldrich Cat. Nos. GSWP09000, GSWP14250, GSWP01300), and 02 μm pore diameters (Sigma-Aldrich Cat. Nos. WHA10401770, WHA10401712, WHA10401714).

In some instances, the substrate can be a nitrocellulose membrane. Exemplary commercially available nitrocellulose substrates include filter membranes with 1 μm pore diameters (Sigma-Aldrich Cat. Nos. WHA7190002, WHA7190004), 0.8 μm pore diameters (Sigma-Aldrich Cat. Nos. WHA7188002, WHA7188003, WHA7188004), 0.65 μm pore diameters (Sigma-Aldrich Cat. No. WHA7186004), 0.45 μm pore diameters (Sigma-Aldrich Cat. Nos. WHA7141004, WHA7141104, WHA7141114), 0.22 μm pore diameters (Sigma-Aldrich Cat. Nos. N8645, N8395, Z358657), 0.2 μm pore diameters (Sigma-Aldrich Cat. Nos. WHA7182002, WHA7182004, WHA7187114), and 0.1 μm pore diameters (Sigma-Aldrich Cat. Nos. WHA7181002, WHA7181004).

In some instances, the substrate can be a polycarbonate (PC) membrane. Exemplary commercially available PC substrates include filter membranes with 0.8 μm pore diameters (Sigma-Aldrich Cat. Nos. ATTP01300, ATTP14250, ATTP03700), 0.6 μm pore diameters (Sigma-Aldrich Cat. Nos. DTTP01300, DTTP02500), 0.4 μm pore diameters (Sigma-Aldrich Cat. Nos. HTTP02500, HTTP04700), 0.2 μm pore diameters (Sigma-Aldrich Cat. Nos. GTTP14250, GTTP02500), and 0.1 μm pore diameters (Sigma-Aldrich Cat. Nos. VCTP04700, VCTP02500, VCTP14250).

In some instances, the substrate can be a polyethersulfone (PES) membrane. Exemplary commercially available PES substrates include filter membranes with 0.45 μm pore diameters (Sigma-Aldrich Cat. Nos. HPWP02500, HPWP14250), and 0.22 μm pore diameters (Sigma-Aldrich Cat. Nos. GPWP01300, GPWP09050).

In some instances, the substrate can be a polyether ether ketone (PEEK) membrane. Exemplary commercially available PEEK substrates include fitter membranes with 0.1 μm pore diameters (Sterlitech Cat. Nos. 1120723, 1120724).

In some instances, the substrate can be a polyester membrane. In some instances, the polyester membrane can be hydrophilic. In some instances, the polyester membrane can be hydrophobic. Exemplary commercially available polyester substrates include filter membranes with 1 μm pore diameters (Sterlitech Cat. Nos. PET1013100, PET1025100, PET1047100), 0.8 μm pore diameters (Sterlitech Cat. Nos. PET0812100, PET089030, 130006), 0.4 μm pore diameters (Sterlitech Cat. Nos. 1300017, 1300018, 1300019), 0.2 μm pore diameters (Sterlitech Cat. Nos. PET0220030, PET02142200, 1300011, 1300012, 1300015), and 0.1 μm pore diameters (Sterlitech Cat. Nos. PET0113100, PET0125100, PET0147100).

In some instances, the substrate can be a polyacrylonitrile-laminated polyester membrane. Exemplary commercially available polyacrylonitrile-laminated polyester substrates include filter membranes with 0.2 μm pore diameters (Sterlitech Cat. Nos. PAN023001, PAN022005, PAN029025, PAN0247100, PAN0225100).

In some instances, the substrate can be a polyvinylidene fluoride (PVDF) membrane. In some instances, the PVDF membrane can be hydrophilic. In some instances, the PVDF membrane can be hydrophobic. Exemplary commercially available PVDF substrates include filter membranes with 1 μm pore diameters, 0.65 μm pore diameters (Sigma-Aldrich Cat. Nos. DVPP04700, DVPP00010, DVPP14250), 0.45 μm pore diameters (Sigma-Aldrich Cat. Nos. HVLP09050, HVLP00010, HVHP14250, HVHP01300), 0.22 μm pore diameters (Sigma-Aldrich Cat. Nos. GVHP00010, GVHPO2500, GVWP00010, GVWPO2500), and 0.1 μm pore diameters (Sigma-Aldrich Cat. Nos. VVLP01300, VVLP04700, VVLP09050, VVLP02500, VVHP04700).

In some instances, the substrate can be a polytetrafluoroethylene (PTFE) membrane. In some instances, the PTFE membrane can be hydrophilic. In some instances, the PTFE membrane can be hydrophobic. Exemplary commercially available PTFE substrates include filter membranes with 1 μm pore diameters (Sigma-Aldrich Cat. Nos. WHA7590004, WHA7590002, WHA10411213, JAWP14225), 0.5 μm pore diameters (Sigma-Aldrich Cat. No. WHA7585004), 0.45 μm pore diameters (Sigma-Aldrich Cat. Nos. WHA10411305, WHA10411311, JHWP09025), 0.4 μm pore diameters (Sigma-Aldrich Cat. No. BGCM00010), 0.2 μm pore diameters (Sigma-Aldrich Cat. Nos. WHA7582002. WHA7582004, WHA10411405, JGWP04700), and 0.1 μm pore diameters (Sigma-Aldrich Cat. No. JVWP09025).

In some instances, the substrate can be a polyalkylene membrane. In some instances, the polyalkylene membrane can be a polypropylene membrane. Exemplary commercially available polypropylene substrates include filter membranes with 0.45 μm pore diameters (Cole-Parmer Cat. Nos. EW-12917-90, EW-12917-91; VWR Cat. Nos. 28143-014, 28140-160), and 0.22 μm pore diameters (Cole-Parmer Cat. Nos. EW-12917-88, EW-12917-89; VWR Cat. No. 28140-037).

In some instances, the substrate can be a glass fiber membrane. Exemplary commercially available glass fiber substrates include filter membranes with 1 μm pore diameters (Sigma-Aldrich Cat. Nos. AP1512450, AP1514250, AP1509000, APFB04700), and 0.7 μm pore diameters (Sigma-Aldrich Cat. Nos. AP4004700, AP4007000, AP408X105).

In some instances, the substrate can be an aluminum oxide membrane. Exemplary commercially available aluminum oxide substrates include filter membranes with 0.2 μm pore diameters (Sterlitech Cat. Nos. 1360016, 1360017, 1360018), and 0.1 μm pore diameters (Sterlitech Cat. Nos. 1360013, 1360014, 1360015).

In some instances, the substrate can be a ceramic membrane. Exemplary commercially available ceramic substrates include filter membranes with 0.8 μm pore diameters (Sterlitech Cat. Nos. 90M080, 47M080), 0.45 μm pore diameters (Sterditech Cat. Nos. 90M045, 47M045), 0.2 μm pore diameters (Sterlitech Cat. Nos. 90M020, 47M020), and 0.14 μm pore diameters (Sterlitech Cat. Nos. 90M014, 47M014).

In some instances, the substrate can be a silver membrane. Exemplary commercially available silver substrates include filter membranes with 0.8 μm pore diameters (Sigma-Aldrich Cat. No. Z623032; Cole-Parmer Cat. Nos. EW-06741-22, EW-06741-24, EW-06741-26), 0.5 μm pore diameters (Fisher Scientific Cat. Nos. AG4502550), 0.45 μm pore diameters (Sigma-Aldrich Cat. No. Z623040; Cole-Parmer Cat. Nos. EW-06741-18, EW-06741-20), and 0.2 μm pore diameters (Sigma-Aldrich Cat. No. Z623059; Cole-Parmer Cat. Nos. EW-06741-10, EW-06741-12, EW-06741-14).

### F. Methods of Making the Disclosed Block Copolymer (BCP) Films

In some instances, the methods of the disclosure can be used to produce hybrid multi-layer graded BCP films. In some instances, a hybrid multi-layer graded BCP film can be produced from two or more multibock copolymers. In some instances, a hybrid multi-layer graded BCP film can be produced from a multiblock copolymer and a homopolymer. In some instances, a hybrid multi-layer graded BCP film can be produced from a multiblock copolymer and a small molecule. In some instances, a hybrid multi-layer graded BCP film can be produced from a multiblock copolymer, a homopolymer and a small molecule. Accordingly, the deposition solutions, as described herein, can also include a homopolymer and/or a small molecule.

A deposition solution (or casting solution) is used to form an initial film comprising a multiblock copolymer on the substrate. The deposition solution includes at least a multiblock copolymer and a solvent system. In some instances, it has been found particularly advantageous that the solvent system include at least 1,4-dioxane. In some instances, the solvent system can also include one or more additional solvents. In some instances, the one or more additional solvent is or includes a polar solvent. In some instances, the one or more additional solvent is or includes a polar aprotic solvent. Examples of suitable additional solvents include, but are not limited to tetrahydrofuran, acetone, methanol, ethanol, isopropanol, N-methyl-2-pyrrolidone (NMP), toluene, chloroform, dimethylformamide (DMF), and dimethylsulfoxide (DMSO). In various examples, the solvent system is 1,4-dioxane or a mixture of solvents where at least one of the solvents in the mixture is 1,4-dioxane. In some instances, the solvent system has about 10 wt % to about 99 wt % 1,4-dioxane. In some instances, the solvent system has about 20 wt % to about 95 wt %, alternatively about 30 wt % to about 90 wt %, alternatively about 40 to about 85 wt %, and alternatively about 50 wt % to about 80 wt % 1,4-dioxane. In some instances, a suitable solvent system is 70/30 (% w/w) 1,4-dioxane/tetrahydrofuran. In some instances, a suitable solvent system is 70/30 (% w/w) 1,4-dioxane/acetone.

At least a portion of the solvent(s) in the solvent system is removed from the initial film after the initial film is formed from the deposition solution prior to contacting the film with a phase separation solvent system. Without intending to be bound by any particular theory, it is considered the solvent removal results in pores oriented perpendicular to the thin dimension of the film (i.e., the dimension normal to the substrate). For example, from about 1 wt % to about 80 wt %, including all integer values of % by weight and ranges therebetween, of the solvent(s) is removed. The amount of solvent in the film before, during, and after removal can be measured by techniques such as infrared or UV/vis spectroscopy, or thermogravimetric analysis (TGA).

In some instances, at least a portion of the solvent(s) in the initial film is removed by allowing the initial film to stand for a period of time sufficient for the solvent(s) to evaporate. The solvent evaporation is a variable process and can take place over a wide range of times (e.g., from seconds to minutes). The time is dependent upon, for example, the deposition solution composition and surrounding environmental conditions. The solvent removal step can include flowing a gas (such as air, argon, and nitrogen), exposing the film to reduced pressure and/or increased atmospheric temperatures. Such steps can increase the rate of solvent removal. The degrees of gas flow (and type of gas used), pressure reduction and/or increased atmospheric pressure may need to varied to ensure efficient solvent evaporation based on the inherent properties of the particular solvent or solvent system used, such as the volatility and boiling point.

After the solvent removal step, the film is contacted with a phase separation solvent system. This step is referred to herein as a NIPS (non-solvent induced phase separation) process. The solvent system can be a single solvent or a mixture of solvents. The solvent system is a non-solvent for the multiblock copolymer (that is, at least one of the blocks of the multiblock copolymer precipitates in the solvent system). Further, in the case where 1,4-dioxane is used in the deposition solution, 1,4-dioxane must be miscible with the non-solvent for the NIPS process. Examples of suitable solvents for use in the NIPS process include water, methanol, ethanol, acetone, and combinations thereof. In some instances, the phase separation solvent system is in the form of a coagulation bath. In some instances, the use of a water coagulation bath is preferred. Without intending to be bound by any particular theory, it is considered that contacting the initial film with a non-solvent causes blocks of the multiblock copolymer in the initial film to precipitate. After precipitation, the structure of the resulting film is set due to vitrification of the multiblock copolymer. This step results in formation of a multi-layered graded BCP film.

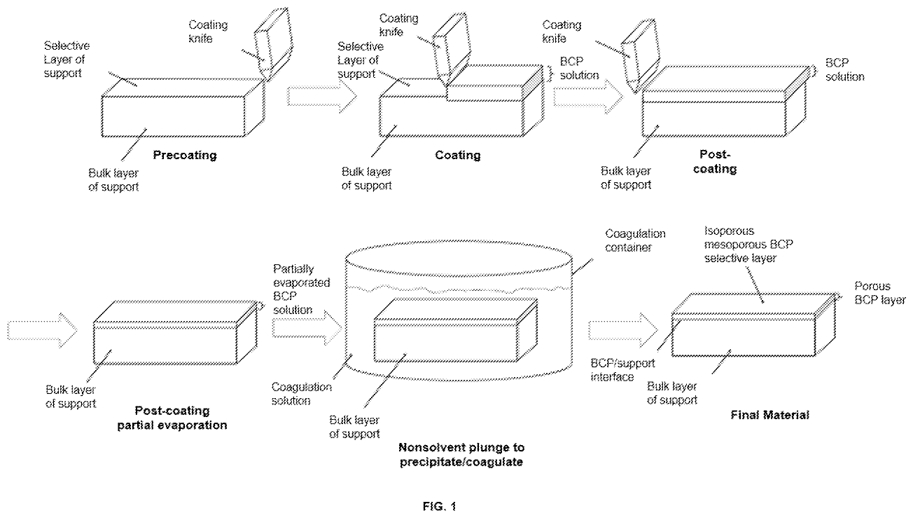

A schematic illustration of an exemplary procedure for forming a multi-layer graded BCP film as described above is shown in FIG. 1. It should be understood, with reference to FIG. 1, that In FIG. 1, the “Bulk layer of support” refers to “substrate” as used herein throughout, and the “Selective layer of support” refers to the upper surface of the substrate (or as referred to in the figure, “bulk layer of support”).

The films resulting from the method have at least three identifiable layers. The first identifiable layer is a first porous “skin” layer formed on the surface of the substrate. The second identifiable layer is a porous bulk layer formed on the first porous “skin” layer. The third identifiable layer is a second porous “skin” layer formed on the surface of the porous bulk layer. The resulting films therefore exhibit a sandwich-type structure with a porous bulk layer situated between porous skin layers. The resulting film can be removed from the substrate providing a free-standing sandwich-structured film with three identifiable layers. While the resulting film may have at least three identifiable layers, the film itself constitutes a continuous film structure where each layer is chemically and/or physically bonded to adjacent layers and the adjacent layers are at least partially interconnected by pores, allowing for the transmission of one or more fluids between adjacent layers.

In some instances, the films resulting from the method have at least five identifiable layers. The first identifiable layer is a first porous “skin” layer formed on the surface of the substrate. The second identifiable layer is a porous bulk layer formed on the first porous “skin” layer. The third identifiable layer is a second porous “skin” layer formed on the surface of the porous bulk layer. The fourth identifiable layer is a first porous transition layer (also referred to herein as an “interface” or “interfacial layer”) structure between the first skin layer and the bulk layer and having physical and/or chemical characteristics of both the first skin layer and the bulk layer. The fifth identifiable layer is a second porous transition layer also referred to herein as an “interface” or “interfacial layer”) structure between the second skin layer and the bulk layer and having physical and/or chemical characteristics of both the second skin layer and the bulk layer. The resulting films therefore exhibit a sandwich-type structure with a porous bulk layer situated between porous skin layers, and a transition layer between each of the first and second skin layers and the bulk layer. The resulting film can be removed from the substrate providing a free-standing sandwich-structured film with five identifiable layers. While the resulting film may have at least five identifiable layers, the film itself constitutes a continuous film structure where each layer is chemically and/or physically bonded to adjacent layers and the adjacent layers are at least partially interconnected by pores, allowing for the transmission of one or more fluids between adjacent layers.

The transition or interfacial layers can impart the multi-layer graded BCP films with various beneficial properties. Such beneficial properties include but are not limited to increased rejection of particles larger than the pore size, increased permeability and throughput of feedstreams passed through the multilayer material, enhanced mechanical stability of the multilayer material. For example, multiple interfacial layers may act as rejection layers in series, yielding a multiplicative effect on rejection while only an additive effect in permeability decrease of the layers. For example, a first interfacial layer may exhibit pore sizes in the range of 100 nm in diameter while a second interfacial layer may exhibit pore sizes in the range of 40 nm, excluding feedstream components larger than 100 nm from obstructing or otherwise interfering with the second layer and thus increasing overall permeability. For example, the density of material at the interface may be turned to ensure desired adhesion between two adjacent layers, resulting in enhanced mechanical integrity and limiting know mechanical issues such as delamination.

The concentration of the multiblock copolymer in the deposition solution can be a factor in the physical structure of the resulting cast film. The concentration of multiblock copolymer can be selected based on parameters such as the chemical composition and molecular weight of the multiblock copolymer and the deposition solvent(s). The multiblock copolymer concentration of the deposition solution can be, for example, about 5 wt % to about 50 wt %, including all integer values of % by weight and ranges therebetween. In some instances, the multiblock copolymer concentration of the deposition solution can be from about 6 wt % to about 40 wt %, alternatively from about 7 wt % to about 30 wt %, alternatively from about 7.5 wt % to about 20 wt %, and alternatively from about 8 wt % to about 15 wt %.

The deposition solution can be deposited on a substrate by a variety of methods. Examples of suitable deposition methods include doctor blade coating, dip coating, flow coating, slot die coating, slide coating, inkjet printing, screen printing, gravure (flexographic) printing, spray-coating, and knife coating. For example, when doctor blade coating is used, the gate height can be adjusted to the desired height depending on the concentration of the multiblock copolymer in the deposition solution. In some instances, the doctor blade height can be set at, for example, from about 20 μm (about 0.8) to about 500 μm (about 20 mils), preferably about 20 μm (about 0.8) to about 400 μm (about 16 mils), more preferably about 20 μm (about 0.8 mils) to about 300 μm (about 12 mils), and even more preferably about 25 μm (about 1mils) to about 250 μm (about 10 mils).

In various aspects, the deposition solution is deposited on a substrate as disclosed herein. In a further aspect, the substrate has pores; and wherein the pores have an average pore diameter ranging from about 0.1 μm to about 10 μm. In a still further aspect, the substrate has pores have an average pore diameter ranging from about 0.1 μm to about 3 μm; have an average pore diameter ranging from 0.1 μm to about 1 μm; have an average pore diameter ranging from about 0.22 μm to about 1 μm; or have an average pore diameter ranging from about 0.45 μm to about 1 μm. In a still further aspect, the substrate has pores have an average pore diameter of about 0.1 μm; about 0.22 μm; about 0.45 μm; about 0.65 μm; about 0.7 μm; about 0.8 μm; about 0.9 μm; about 1.0 μm; about 2.0 μm; about 3.0 μm; about 4.0 μm; or about 5.0 μm.

Multi-layer graded BCP films according to the disclosure can have a variety of shapes. One having skill in the art will appreciate that films having a variety of shapes can be fabricated. The films can have a broad range of sizes (e.g., film thicknesses and film area). For example, the films can have a thickness of from 5 microns to 100 microns, including all values to the micron and ranges therebetween. Depending on the application (e.g., bench-top applications, biopharmaceutical applications, and water purification applications, the films can have areas ranging from 10 s of cm² to 10 s (even 100 s) of m². In some instances, multi-layer graded BCP films can be fabricated on substrates which are pre-cut to have a defined shape such as, for example, a circular or square wafer having a dimensions suitable for placement within a circular filtration tube or a rectangular filtration cassette. In some instances, multi-layer graded BCP films can be fabricated on a continuous roll or sheet of a substrate, and the resulting substrate-supported multi-layer graded BCP films can later be cut to have a desired shape for any suitable application such as, for example, a circular or square substrate-supported multi-layer graded BCP filter membrane having a diameter suitable for placement within a circular filtration tube or a rectangular filtration cassette. In some instances, the multi-layer graded BCP films can be removed from the underlying substrate to form free-standing films.

In some embodiments, the multi-layer graded BCP films according to the disclosure, whether disposed on a substrate or free-standing are incorporated into a filtration device.

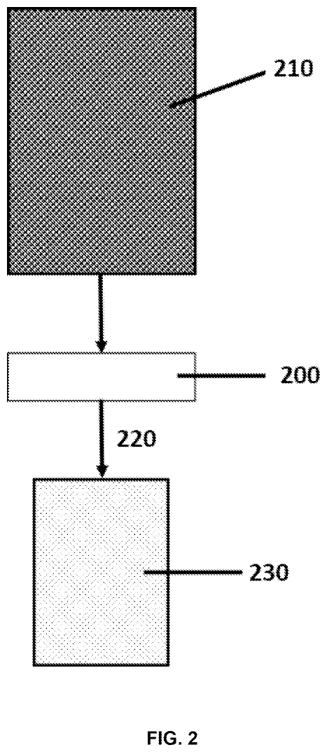

In at least one embodiment, for example as depicted in FIG. 2, a multi-layer graded BCP film (free-standing or substrate-supported) 200 is contacted with a fluid (that is, a liquid, gas, liquid/gas mixture, liquid/solid mixture, gas/sold mixture, gas/liquid/solid mixture) comprising solid particles 210, causing the solid particles to be separated or removed from the fluid, and a permeate 220, is collected as a once fractionated fluid 230.

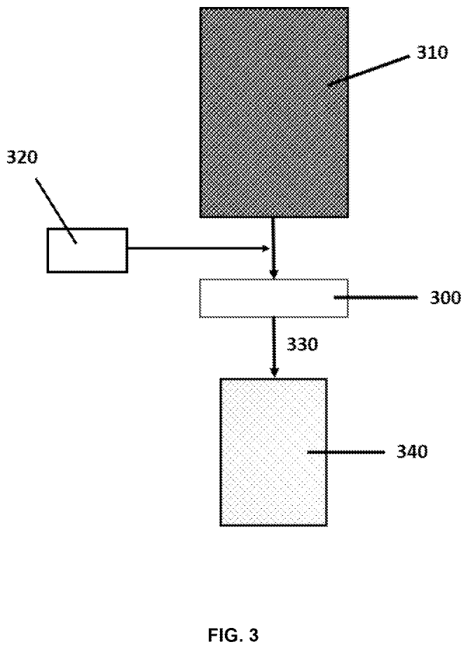

In some embodiments, for example as depicted in FIG. 3, a multi-layer graded BCP film (free-standing or substrate-supported) 300 is contacted with a fluid (that is, a liquid, gas, liquid/gas mixture, liquid/solid mixture, gas/sold mixture, gas/liquid/solid mixture) comprising solid particles 310 and a pressure differential is applied across the multi-layer graded BCP film 300 using a pressurization source 320, causing the solid particles to be separated or removed from the fluid, and a permeate 330 is collected as a once fractionated fluid 340.

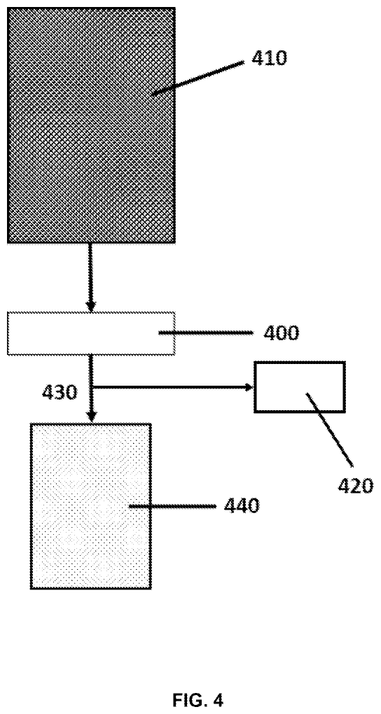

In some embodiments, for example as depicted in FIG. 4, a multi-layer graded BCP film (free-standing or substrate-supported) 400 is contacted with a fluid (that is, a liquid, gas, liquid/gas mixture, liquid/solid mixture, gas/sold mixture, gas/liquid/solid mixture) comprising solid particles 410 and a pressure differential is applied across the multi-layer graded BCP film 400 using a vacuum source 420, causing the solid particles to be separated or removed from the liquid, and a permeate 430 is collected as a once fractionated liquid 440.

In at least one embodiment, a device in accordance with various aspects of the present disclosure comprises a multi-layer graded BCP film, an inlet to allow a fluid (a liquid, gas, liquid/gas mixture, liquid/solid mixture, gas/sold mixture, gas/liquid/solid mixture) to contact the multi-layer graded BCP film, and an outlet to allow passage of a purified fluid therethrough.

### G. Devices

In at least one embodiment, a device in accordance with various aspects of the present disclosure comprises a multi-layer graded BCP film, an inlet to allow a fluid (a liquid, gas, liquid/gas mixture, liquid/solid mixture, gas/sold mixture, gas/liquid/solid mixture) to contact the multi-layer graded BCP film, an outlet to allow passage of a purified fluid therethrough, and a receiving vessel to capture purified fluid.

In at least one embodiment, a device in accordance with various aspects of the present disclosure comprises a multi-layer graded BCP film (free-standing or substrate-supported), an inlet to allow a fluid (that is, a liquid or mixture of liquids, a gas or mixture of gases, a liquid/gas mixture, a liquid/solid mixture, a gas/sold mixture, a gas/liquid/solid mixture) to contact the multi-layer graded BCP film, an outlet to allow passage of a purified liquid therethrough, and a vent to remove purified gas from the device.

In at least one embodiment, a device in accordance with various aspects of the present disclosure comprises a multi-layer graded BCP film (free-standing or substrate-supported), an inlet to allow a fluid (that is, a liquid or mixture of liquids, a gas or mixture of gases, a liquid/gas mixture, a liquid/solid mixture, a gas/sold mixture, a gas/liquid/solid mixture) to contact the multi-layer graded BCP film, an outlet to allow passage of a purified liquid therethrough, a receiving vessel for capturing the purified liquid, a vent to remove purified gas from the device, and a receiving vessel for capturing the purified gas.

In some embodiments, a device in accordance with various aspects of the present disclosure comprises an inlet and the inlet can be part of a housing for a multi-layer graded BCP film (free-standing or substrate-supported). For example, in at least one embodiment the inlet can be a molded plastic part of a syringe filter. In other embodiments, the inlet can simply be the exposed surface of a multi-layer graded BCP film wherein fluid can be introduced to contact the multi-layer graded BCP film. For example, in at least one embodiment the inlet can be the most selective portion of a multi-layer graded BCP film wherein the multi-layer graded BCP film is a free-standing or substrate-supported flat sheet membrane.

In some embodiments, a device in accordance with various aspects of the present disclosure comprises an outlet and the outlet can be part of a housing for a multi-layer graded BCP film (free-standing or substrate-supported). For example, in at least one embodiment the outlet can be a plastic part of a hollow fiber module. In other embodiments, the outlet can simply be the exposed surface of a multi-layer graded BCP film wherein fluid can exit the multi-layer graded BCP film. For example, in at least one embodiment the outlet can be the least selective portion of a multi-layer graded BCP film wherein the multi-layer graded BCP film is a free-standing or substrate-supported flat sheet membrane attached to the bottom of a multiple well plate.

In some embodiments, a device in accordance with various aspects of the present disclosure comprises a vent for removing gas from the device as or after a fluid is introduced. In at least one embodiment, the vent can be an opening that can be opened or closed. For example, in at least one embodiment, the vent is a valve incorporated into a housing that can be manually or remotely actuated to transition between an open state, partially open state, or closed state. In at least one embodiment, the vent is a molded part of a housing that has a removable cap, cover, or fitting allowing for opening, partial opening, and closing. In at least one embodiment, the vent is an opening or connection where an external valve, fitting, connector, cover, or cap can be connected, and used to meter the vent between an open state and a closed state.

In some embodiments, a device in accordance with various aspects of the present disclosure comprises a receiving vessel to capture purified liquid. In some embodiments, the receiving vessel is an integrated portion of the device. In some embodiments, the receiving vessel is a removable portion of the device.

In some embodiments, a multi-layer graded BCP film (free-standing or substrate-supported) is packaged as or in a device including, for example: a pleated pack, one or more flat sheets in a cassette, a spiral wound module, hollow fibers, a hollow fiber module, a syringe filter, a microcentrifuge tube, a centrifuge tube, a spin column, a multiple well plate, a vacuum filter, or a pipette tip. In an embodiment, such a device can utilize more than one different material of the disclosure.

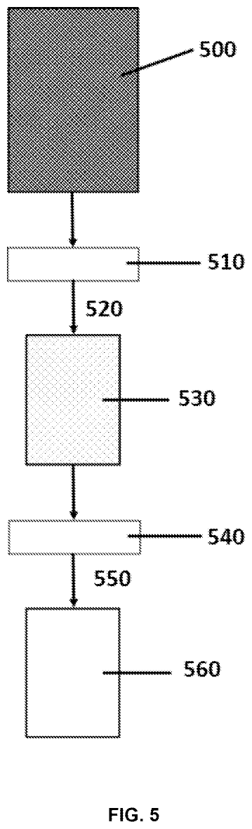

In some embodiments, more than one multi-layer graded BCP film or device comprising a multi-layer graded BCP film (free-standing or substrate-supported) is used during purification of a fluid (that is, a liquid, gas, liquid/gas mixture, liquid/solid mixture, gas/solid mixture, gas/liquid/solid mixture) comprising one or more sizes of solid particles. In an embodiment as depicted in FIG. 5 for example, a fluid comprising solid particles 500 is contacted with a multi-layer graded BCP film 510, and a permeate 520 is collected as a once purified fluid 530. The once purified fluid 530 is subsequently contacted with a second multi-layer graded BCP film 540, and a permeate 550 is collected as a twice purified fluid 560.

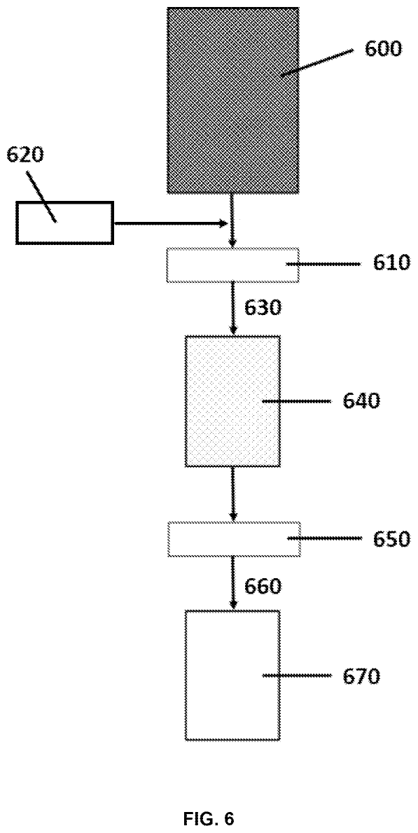

In an embodiment as depicted in FIG. 6 for example, a fluid (that is, a liquid, gas, liquid/gas mixture, liquid/solid mixture, gas/solid mixture, gas/liquid/solid mixture) comprising solid particles 600 is contacted with a multi-layer graded BCP film (free-standing or substrate-supported) 610 and pressurized using a pressurization source 620, and a first permeate 630 is collected as a once purified fluid 640. The once purified fluid 640 is subsequently contacted with a second multi-layer graded BCP film 650, and a second permeate 660 is collected as a twice purified fluid 670.

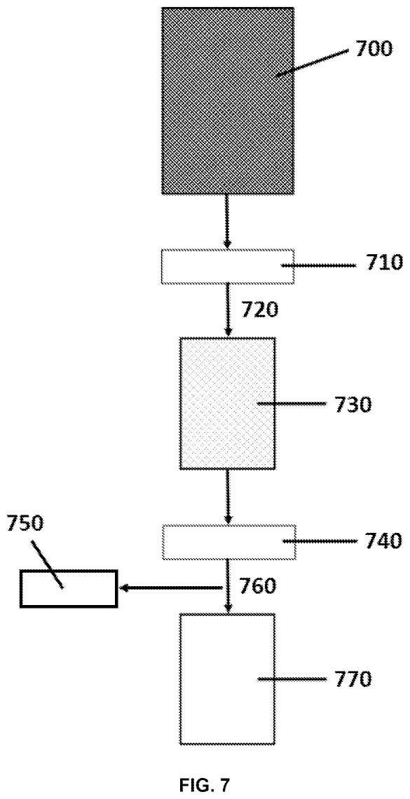

In an embodiment as depicted in FIG. 7 for example, a fluid (that is, a liquid, gas, liquid/gas mixture, liquid/solid mixture, gas/solid mixture, gas/liquid/solid mixture) comprising solid particles 700 is contacted with a multi-layer graded BCP film (free-standing or substrate-supported) 710, and a first permeate 720 is collected as a once purified fluid 730. The once purified fluid 730 is subsequently contacted with a second multi-layer graded BCP film 740, and vacuum is applied across the film using a vacuum source 760. A second permeate 770 is collected as a twice purified fluid 780.

In an example of an embodiment, a syringe filter device comprising a multi-layer graded BCP film (free-standing or substrate-supported) is contacted with a fluid (that is, a liquid, gas, liquid/gas mixture, liquid/solid mixture, gas/solid mixture, gas/liquid/solid mixture) comprising solid particles and a pressure gradient is applied across the syringe filter device, facilitating the separation of larger particles. Subsequently, the permeate is contacted with a surface functionalized multi-layer graded BCP material packaged in a pipette tip and a pressure differential is applied across the multi-layer graded BCP material, facilitating the separation of some of the smaller particles.

In some embodiments, at least one multi-layer graded BCP film or device comprising a multi-layer graded BCP film (free-standing or substrate-supported) is operated in crossflow or tangential flow mode, wherein the fluid (that is, a liquid, gas, liquid/gas mixture, liquid/solid mixture, gas/solid mixture, gas/liquid/solid mixture) comprising solid particles is passed tangential to the multi-layer graded BCP film. In some such embodiments, more than one multi-layer graded BCP film or device comprising a multi-layer graded BCP film is used for the separation of solid particles from the fluid.

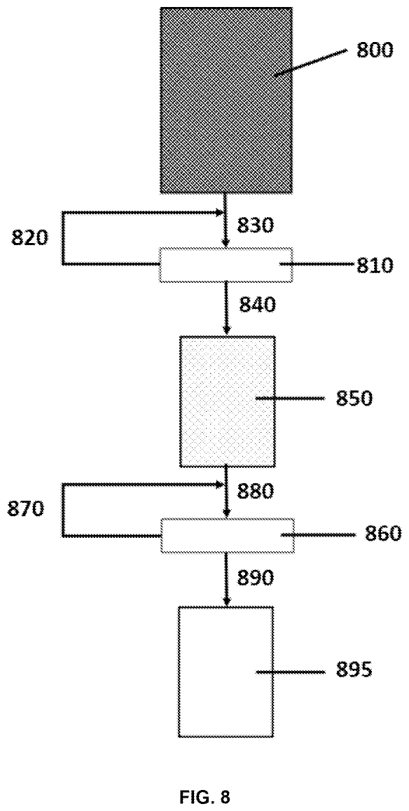

In an embodiment, as depicted in FIG. 8 for example, a fluid comprising solid particles 800 is first separated by contacting a first multi-layer graded BCP film (free-standing or substrate-supported) 810 in crossflow mode, where a first retentate 820 is cycled back into a first feed 830 and a first permeate 840 from the first separation is collected as a once purified fluid 850. The once purified fluid 850 is then contacted with a second multi-layer graded BCP film 860 in crossflow mode, where a second retentate 870 is cycled back into a second feed 880 and a second permeate 890 from the second separation is collected as a twice purified fluid 895.

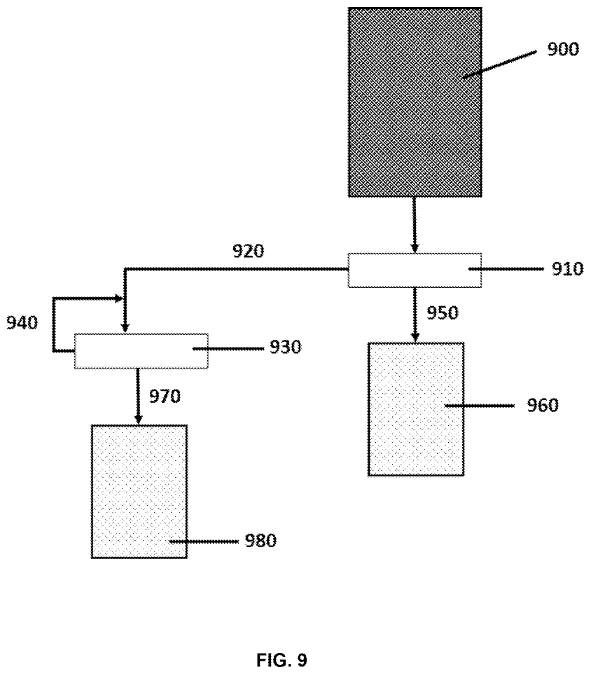

In an embodiment, as depicted in FIG. 9 for example, a fluid comprising solid particles 900, is first separated by contacting a first multi-layer graded BCP film (free-standing or substrate-supported) 910 in crossflow mode, where a first retentate 920 is further separated by a second multi-layer graded BCP film 930 in crossflow mode where a second retentate 940 can optionally be cycled back into a feed of the first retentate 920. A first permeate 950, obtained from the first separation using the first multi-layer graded BCP film 910, is collected as a once purified fluid 960. A second permeate 970, obtained from further separation of the first retentate 920, and optionally the second retentate 940, using the multi-layer graded BCP film 930, is also collected as a fractionated liquid 980. In another exemplary embodiment, a liquid comprising encapsulating particles is first separated by a mesoporous isoporous block copolymer material in crossflow mode, and secondly, the retentate from the first separation is then contacted with a second multi-layer graded BCP film in crossflow mode for further separation.

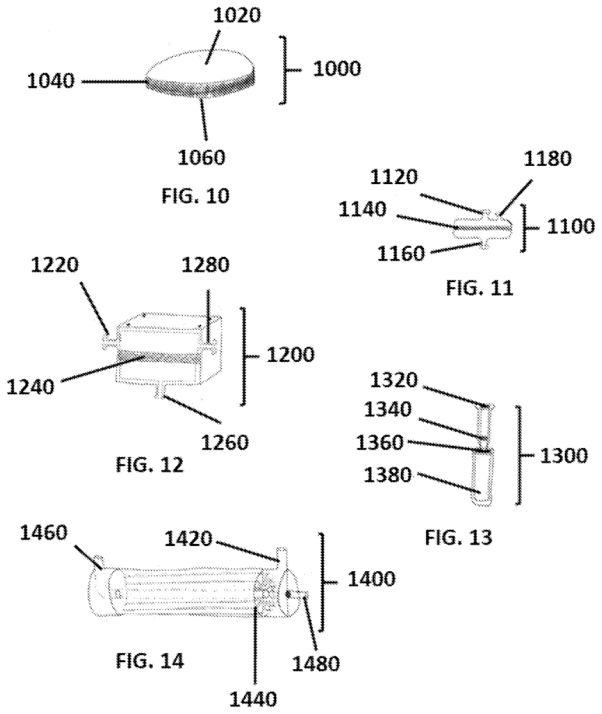

In some instances, a device in accordance with various aspects of the present disclosure can be, for example, a flat sheet 1000 having an inlet 1020, a multi-layer graded BCP film (free-standing or substrate-supported) 1040, and an outlet 190; a configuration of such a device can be as illustrated in FIG. 10.

In some instances, a device in accordance with various aspects of the present disclosure can be, for example, a syringe filter 1100 having an inlet 1120, a multi-layer graded BCP film (free-standing or substrate-supported) 1140, an outlet 1160, and a vent 1180; a configuration of such a device can be as illustrated in FIG. 11.

In some instances, a device in accordance with various aspects of the present disclosure can be, for example, a crossflow module 1200 having an inlet 1220, a multi-layer graded BCP film (free-standing or substrate-supported) 1240, an outlet 1260, and a retentate port 1280; a configuration of such a device can be as illustrated in FIG. 12.

In some instances, a device in accordance with various aspects of the present disclosure device can be, for example, a spin column 1300 having an inlet 1320, a multi-layer graded BCP film (free-standing or substrate-supported) 1340, an outlet 1360, and a receiving vessel 1380; a configuration of such a device can be as illustrated in FIG. 13.

In some instances, a device in accordance with various aspects of the present disclosure can be, for example, and a pleated capsule 1400 having an inlet 1420, a multi-layer graded BCP film (free-standing or substrate-supported) 1440, an outlet 1460, and a vent 1480; a configuration of such a device can be as illustrated in FIG. 14.

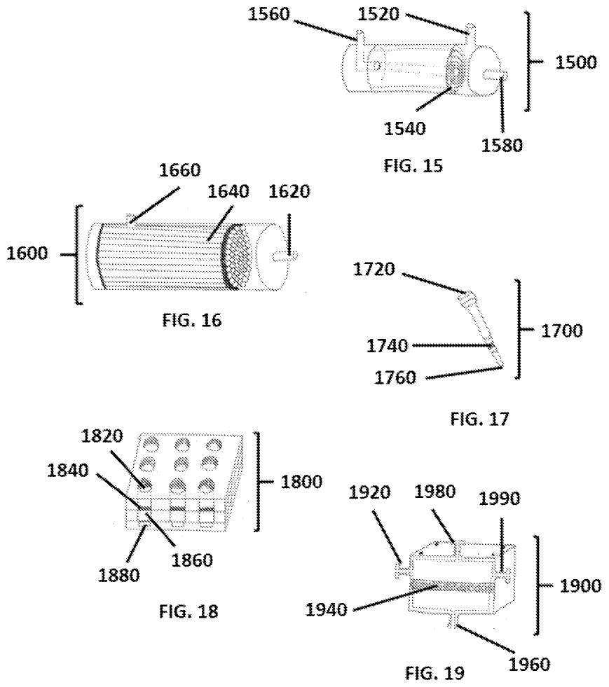

In some instances, a device in accordance with various aspects of the present disclosure can be, for example, a spiral wound module 1500 having an inlet 1520, a multi-layer graded BCP film (free-standing or substrate-supported) 1540, and an outlet 1560, and a vent or retentate port 1580; a configuration of such a device can be as illustrated in FIG. 15.

In some instances, a device in accordance with various aspects of the present disclosure can be, for example, a hollow fiber module 1600 having an inlet 1620, a multi-layer graded BCP film (free-standing or substrate-supported) 1640, and an outlet 1660; a configuration of such a device can be as illustrated in FIG. 16.

In some instances, the device can be, for example, a pipette tip 1700 having an inlet 1720, a multi-layer graded BCP film (free-standing or substrate-supported) 1740, and an outlet 1780; a configuration of such a device can be as illustrated in FIG. 17.

In some instances, a device in accordance with various aspects of the present disclosure can be, for example, a multiple well plate 1800, having an inlet 1820, a multi-layer graded BCP film (free-standing or substrate-supported) 1840, an outlet 1860, and a receiving vessel 1880; a configuration of such a device can be as illustrated in FIG. 18.

In some instances, the device can be, for example, a crossflow module 1900 having an inlet 1920, a multi-layer graded BCP film (free-standing or substrate-supported) 1940, an outlet 1960, and a vent 1980 and retentate port 1990; a configuration of such a device can be as illustrated in FIG. 19.

In some embodiments, free-standing or substrate-supported multi-layer graded BCP films according to the disclosure are incorporated into a filtration device which is used in a protein purification process.

In some embodiments, free-standing or substrate-supported multi-layer graded BCP films according to the disclosure are incorporated into a filtration device which is used in a virus reduction or removal process.

In some embodiments, free-standing or substrate-supported multi-layer graded BCP films according to the disclosure are incorporated into a filtration device which is used in a process purifying a feedstream comprising a fluid for microelectronics manufacturing.

In some embodiments, free-standing or substrate-supported multi-layer graded BCP films according to the disclosure are incorporated into a filtration device which is used in a process purifying a feedstream comprising a fluid for food and beverage production

In some embodiments, free-standing or substrate-supported multi-layer graded BCP films according to the disclosure are incorporated into a filtration device which is used in a process purifying a water for ultrapure water (UPW).

In some embodiments, free-standing or substrate-supported multi-layer graded BCP films according to the disclosure are incorporated into a filtration device and is used in a process of purifying a fluid that contains one or more solutes.

In some embodiments, the free-standing or substrate-supported multi-layer graded BCP films according to the disclosure are incorporated into a filtration device which is subsequently operated in a dead-end filtration configuration during a process purifying a fluid that contains one or more solutes.

In some embodiments, the free-standing or substrate-supported multi-layer graded BCP films according to the disclosure are incorporated into a filtration device which is subsequently operated in a tangential flow filtration configuration during a process purifying a multi-layer graded BCP films that contains one or more solutes.

In some embodiments, the free-standing or substrate-supported multi-layer graded BCP films according to the disclosure are incorporated into a filtration device which is subsequently operated during a process wherein a fluid comprising at least one organic solvent that contains one or more solutes is purified.

In some embodiments, the free-standing or substrate-supported multi-layer graded BCP films according to the disclosure are incorporated into a filtration device which is subsequently operated during a process purifying a fluid that contains one or more solutes for use in the electronics manufacturing industry.

In some embodiments, the free-standing or substrate-supported multi-layer graded BCP films are modified to have inorganic material such as metal, metal alloy or metal oxide nanoparticles, incorporated in one or both of the first and second porous skin layers to form a heterogeneous catalyst, or membrane reactor. The membrane reactor can be disposed within a device having a configuration substantially similar to any of those described in FIGS. 2-19 or any other suitable device or reaction vessel. For example, membrane reactors having gold nanoparticles incorporated in one or both of the first and second porous skin layers can be used in CO oxidation reactions. Also for example, membrane reactors having molybdenum-bismuth bimetallic chalcogenide nanoparticles incorporated in one or both of the first and second porous skin layers can be used in for the conversion of CO₂ to methanol. Also for example, membrane reactors having cobalt nanoparticles incorporated in one or both of the first and second porous skin layers can be used in organic oxidation reactions. Also for example, membrane reactors having palladium nanoparticles incorporated in one or both of the first and second porous skin layers can be used in Heck coupling reactions. As can be appreciated, the above membrane reactor are exemplary in nature. One or ordinary skill in the art would readily appreciate that various metal (monometallic or bimetallic), metal alloy or metal oxide nanoparticles can be used in various catalytic processes.

In some embodiments, the free-standing or substrate-supported multi-layer graded BCP films are modified to have an inorganic material, such semiconductor nanomaterials or inorganic phosphor nanoparticles, incorporated in one or both of the first and second porous skin layers to form a heterogeneous photoluminescent film.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Materials and Methods—Examples 1-10.

For examples 1-10 below, a poly(isoprene-b-styrene-b-4-vinylpyridine) (ISV) block copolymer (BCP) having an overall molecular weight of approximately 174 kg/mol was synthesized by anionic polymerization. The approximate molecular weights of the poly(isoprene), poly(styrene) and poly(4-vinylpyridine) blocks were 56.7 kg/mol, 72.3 kg/mol, and 45 kg/mol respectively. A roll of nylon (0.45 μm average pore diameter; Membrane Solutions Corp., Auburn Wash.) was used as received without modification. 1,4-Dioxane (anhydrous, 99.8%, Sigma Aldrich) and acetone (HPLC grade, >99.9%, Sigma Aldrich) were used as received without further purification. 70 nm particle diameter gold nanoparticles (AuNPs; nanoComposix, San Diego, Calif.) were used as received without further purification or modification. 50 nm particle diameter AuNPs (nanoComposix, San Diego, Calif.) were used as received without further purification or modification. 40 nm particle diameter AuNPs (nanoComposix. San Diego, Calif.) were used as received without further purification or modification. 20 nm particle diameter AuNPs (nanoComposix, San Diego, Calif.) were used as received without further purification or modification. 15 nm particle diameter AuNPs (nanoComposix, San Diego, Calif.) were used as received without further purification or modification. 10 nm particle diameter AuNPs (nanoComposix, San Diego, Calif.) were used as received without further purification or modification. 5 nm particle diameter AuNPs (nanoComposix, San Diego, Calif.) were used as received without further purification or modification.

### Example 1—Preparation of Nylon-Supported Multi-Laver Graded ISV-BCP Film

In this example, a roll of nylon (specifications disclosed above) was supported on a roll-to-roll casting machine equipped with a slot die coater. A solution having 9 wt % of ISV-BCP was prepared by dissolving an appropriate amount of the ISV-BCP in an appropriate amount of a 1,4-dioxane: acetone (70:30% w/w) solvent system. The ISV-BCP solution was then deposited onto the nylon via the slot die coater to result in a ISV-BCP solution film having a wet thickness of 4.36 mils (0.00436 inches). The nylon was dry (that is, not pre-wetted with solvent) prior to and during deposition of ISV-BCP solution.

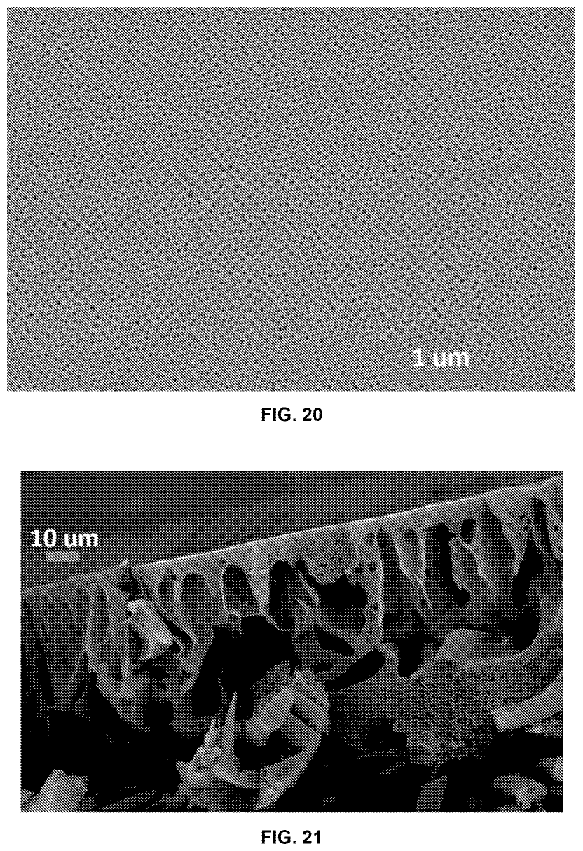

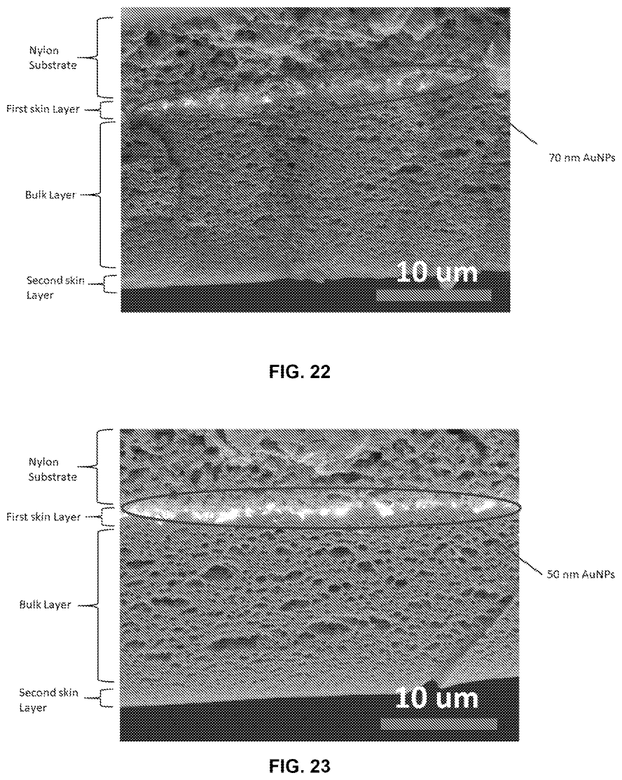

After an amount of time, the nylon having the ISV-BCP solution deposited thereon was plunged into a water coagulation bath to form a nylon-supported multi-layer graded ISV-BCP film. The nylon-supported multi-layer graded ISV-BCP film was then removed from the water coagulation bath and rolled using the roll-to-roll casting machine. The resulting nylon-supported multi-layer graded ISV-BCP film exhibited an external isoporous and mesoporous skin layer followed by a bulk layer, followed by a second mesoporous skin layer interfacing with the nylon support. A scanning electron microscope (SEM) image of the external isoporous and mesoporous skin layer is shown in FIG. 20. The average pore diameters of the bulk layer increase as a function of depth from the external isoporous and mesoporous skin layer to the second mesoporous skin layer. The interface between the second mesoporous skin layer and the nylon support exhibits a decrease relative to the average pore size above the interface, and the interface exhibits mesoporous pores with pore diameters on the same order of magnitude of the pores of the external skin layer. Subsequent analysis of the ISV-BCP film may include removing the film from the nylon support to produce a free-standing ISC-BCP multi-layer graded film and analyzing the second mesoporous skin layer, which previously interfaced with the nylon support to determine if the second skin layer is also isoporous. Cross-sectional SEM images of the nylon-supported multi-layer graded ISV-BCP film are provided in FIGS. 22-29, which are discussed in further detail below.

### Example 2—Comparative Example

In this example, the procedure of experiment 1 was repeated, with the exception that the nylon was dry pre-wetted with solvent prior to a during deposition of ISV-BCP solution. The resulting ISV-BCP film produced in this example does not exhibit a multi-layer graded structure, nor does it exhibit two identifiable skin layers and a bulk layer as in example 1. Instead, the resulting ISV-BCP film irregular macropores and super-macropores extending generally vertically through the thickness of the film, regions of micropores and mesopores disposed between the vertically extending irregular macropores and super-macropores, and a skin layer made of micropores and mesopores. A cross-sectional SEM image of the nylon-supported ISV-BCP film produced in this example is provided in FIG. 21.

### Example 3—Comparative Example

In this example, a disc of the nylon-supported multi-layer graded ISV-BCP film produced in Example 1 was placed in a filter housing with the nylon support facing upward. An aqueous solution of 70 nm average particle diameter gold nanoparticles was placed in the filter housing and, with the application of positive pressure, was forced through the nylon-supported multi-layer graded ISV-BCP film. As shown in the SEM image of FIG. 22, the 70 nm AuNPs passed through the nylon support and accumulated at the first skin layer, indicating the average pore diameter of the first skin layer was equal to or less than 70 nm. The AuNPs, shown as bright spots in the SEM image, are observable using energy dispersive x-ray (EDX) spectroscopy in conjunction with the SEM.

### Example 4—Size-Selective Separation Using Nylon-Supported Multi-Layer Graded ISV-BCP Film

In this example, Example 3 was repeated except a solution of 50 nm average particle diameter AuNPs was used. As shown in the SEM image of FIG. 23, the 50 nm AuNPs passed through the nylon support and accumulated at the first skin layer, indicating the average pore diameter of the first skin layer was equal to or less than 50 nm.

### Example 5—Size-Selective Separation Using Nylon-Supported Multi-Layer Graded ISV-BCP Film

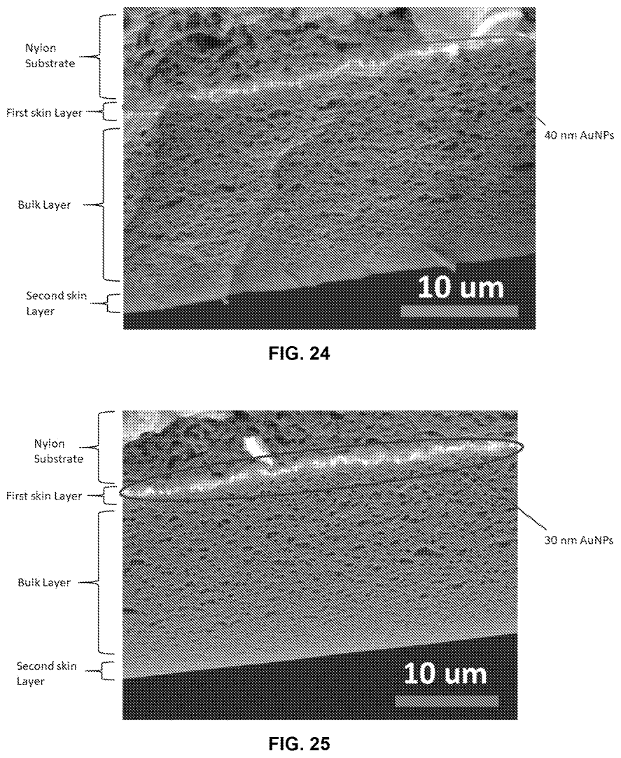

In this example, Example 3 was repeated except a solution of 40 nm average particle diameter AuNPs was used. As shown in the SEM image of FIG. 24, the 40 nm AuNPs passed through the nylon support and accumulated at the first skin layer, indicating the average pore diameter of the first skin layer was equal to or less than 40 nm.

### Example 6—Size-Selective Separation Using Nylon-Supported Multi-Layer Graded ISV-BCP Film

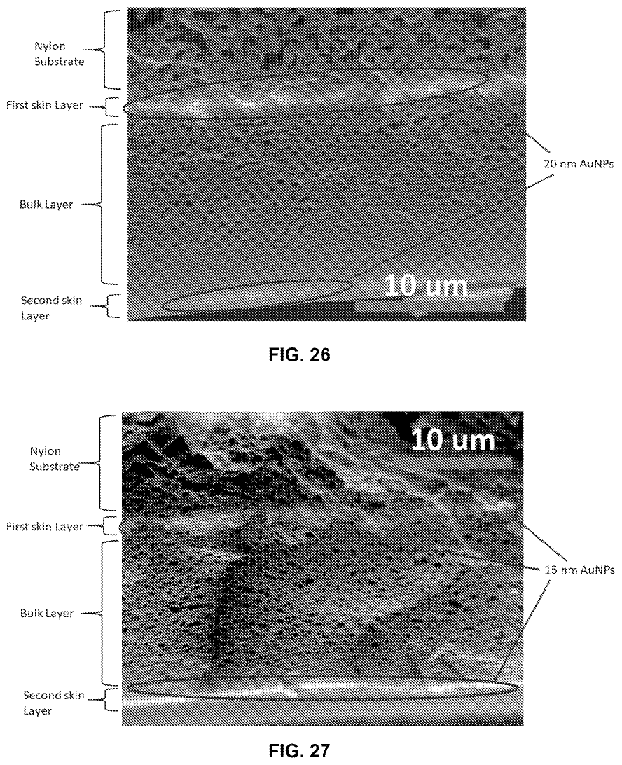

In this example, Example 3 was repeated except a solution of 30 nm average particle diameter AuNPs was used. As shown in the SEM image of FIG. 25, the 30 nm AuNPs passed through the nylon support and accumulated at the first skin layer, indicating the average pore diameter of the first skin layer was equal to or less than 30 nm.

### Example 7—Size-Selective Separation Using Nylon-Supported Multi-Layer Graded ISV-BCP Film

In this example, Example 3 was repeated except a solution of 20 nm average particle diameter AuNPs was used. As shown in the SEM image of FIG. 26, some 20 nm AuNPs passed through the nylon support and accumulated at the first skin layer, and some 20 nm AuNPs passed through the first skin layer and the bulk layer and accumulated in the second skin layer. This indicates that the first skin layer is made of some pores having average pore diameters equal to or less than 20 nm, and some pores having average pore diameters greater than 20 nm. This also indicates that the second skin layer has some pores having average pore diameters equal to or less than 20 nm.

### Example 8—Size-Selective Separation Using Nylon-Supported Multi-Layer Graded ISV-BCP Film

In this example, Example 3 was repeated except a solution of 15 nm average particle diameter AuNPs was used. As shown in the SEM image of FIG. 27, some 15 nm AuNPs passed through the nylon support and accumulated at the first skin layer, and some 15 nm AuNPs passed through the first skin layer and the bulk layer and accumulated in the second skin layer. This indicates that the first skin layer is made of some pores having average pore diameters equal to or less than 15 nm, and some pores having average pore diameters greater than 15 nm. This also indicates that the second skin layer has some pores having average pore diameters equal to or less than 15 nm.

### Example 9—Size-Selective Separation Using Nylon-Supported Multi-Layer Graded ISV-BCP Film

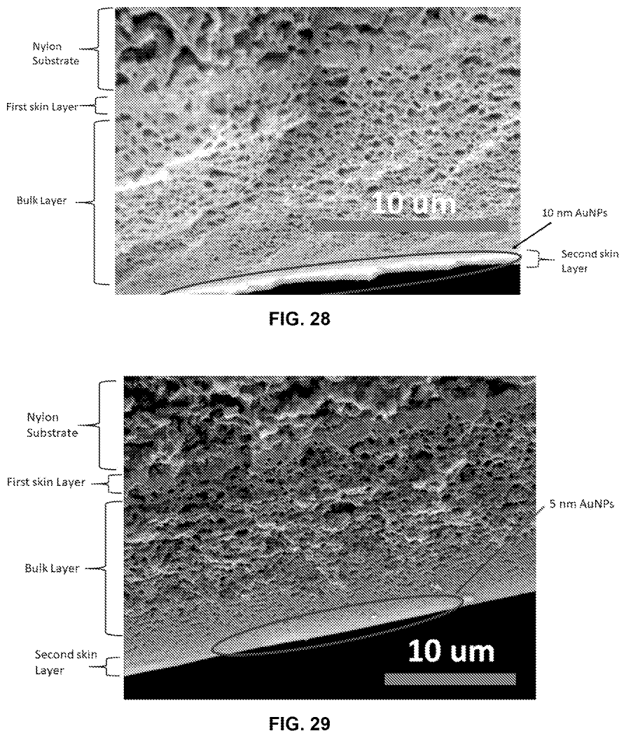

In this example, Example 3 was repeated except a solution of 10 nm average particle diameter AuNPs was used. As shown in the SEM image of FIG. 28, the 10 nm AuNPs passed through the nylon support, the first skin layer and the bulk layer and accumulated in the second skin layer. It does not appear that any appreciable amount of the 10 nm AuNPs accumulated in the second skin layer. This indicates that the first skin layer is made of pores having average pore diameters greater than 10 nm. This also indicates that the second skin layer has some pores having average pore diameters equal to or less than 10 nm.

### Example 10—Size-Selective Separation Using Nylon-Supported Multi-Layer Graded ISV-BCP Film

In this example, Example 3 was repeated except a solution of 5 nm average particle diameter AuNPs was used. As shown in the SEM image of FIG. 29, the 5 nm AuNPs passed through the nylon support, the first skin layer and the bulk layer and accumulated in the second skin layer. It does not appear that any appreciable amount of the 5 nm AuNPs accumulated in the second skin layer. This indicates that the first skin layer is made of pores having average pore diameters greater than 5 nm. This also indicates that the second skin layer has some pores having average pore diameters equal to or less than 5 nm.

### Materials and Methods—Example 11-13.

For examples 11-13 below, a poly(isoprene-b-styrene-b-4-vinylpyridine) (ISV) block copolymer (BCP) having an overall molecular weight of approximately 435 kg/mol was synthesized by anionic polymerization. The approximate molecular weights of the poly(isoprene), poly(styrene) and poly(4-vinylpyridine) blocks were 61 kg/mol, 235 kg/mol, and 139 kg/mol respectively. A roll of nylon (1.0 μm average pore diameter: Membrane Solutions Corp., Auburn Wash.) was used as received without modification. 1,4-Dioxane (anhydrous, 99.8%, Sigma Aldrich) and acetone (HPLC grade, >99.9%, Sigma Aldrich) were used as received without further purification. 40 and 60 nm particle diameter gold nanoparticles (AuNPs; nanoComposix, San Diego, Calif.) were used as received without further purification or modification.

### Example 11—Preparation of Nylon-Supported Multi-Layer Graded ISV-BCP Film and Separation of 40 nm AuNPs

In this example, a roll of nylon (specifications disclosed above) was supported on a roll-to-roll casting machine equipped with a slot die coater. A solution having 11 wt % of ISV-BCP was prepared by dissolving an appropriate amount of the ISV-BCP in an appropriate amount of a 1,4-dioxane: acetone (70:30% w/w) solvent system. The ISV-BCP solution was then deposited onto the nylon via the slot die coater to result in a ISV-BCP solution film having a wet thickness of 3 mils (0.03 inches). The nylon was dry (that is, not pre-wetted with solvent) prior to and during deposition of ISV-BCP solution.

After an amount of time, the nylon having the ISV-BCP solution deposited thereon was plunged into a water coagulation bath to form a nylon-supported multi-layer graded ISV-BCP film. The nylon-supported multi-layer graded ISV-BCP film was then removed from the water coagulation bath and rolled using the roll-to-roll casting machine. The resulting nylon-supported multi-layer graded ISV-BCP film exhibited an external isoporous and mesoporous skin layer followed by a bulk layer, followed by a second mesoporous skin layer interfacing with the nylon support. The average pore diameters of the bulk layer increase as a function of depth from the external isoporous and mesoporous skin layer to the second mesoporous skin layer. Subsequent analysis of the ISV-BCP film may include removing the film from the nylon support to produce a free-standing ISC-BCP multi-layer graded film and analyzing the second mesoporous skin layer, which previously interfaced with the nylon support to determine if the second skin layer is also isoporous.

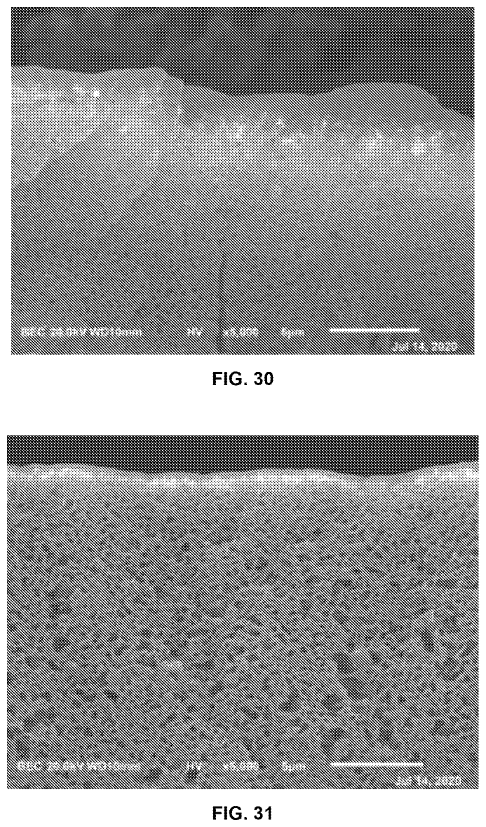

A disc of the nylon-supported multi-layer graded ISV-BCP film produced in this example was placed in a filter housing with the nylon support facing upward. An aqueous solution of 40 nm average particle diameter gold nanoparticles was placed in the filter housing and, with the application of positive pressure, was forced through the nylon-supported multi-layer graded ISV-BCP film. As shown in the SEM image of FIG. 30, the 40 nm AuNPs passed through the nylon support and bulk layer, and accumulated near the external isoporous and mesoporous skin layer. It is likely that the AuNPs accumulated in the interfacial layer between the external skin layer and the bulk layer. This indicates the average pore diameters of the first skin layer, the bulk layer, and the interfacial layer between the first skin layer and the bulk layer are greater than 40 nm. The AuNPs, shown as bright spots in the SEM image, are observable using energy dispersive x-ray (EDX) spectroscopy in conjunction with the SEM.

### Example 12—Preparation of Nylon-Supported Multi-Layer Graded ISV-BCP Film and Separation of 40 nm AuNPs

In this example, a roll of nylon (specifications disclosed above) was supported on a roll-to-roll casting machine equipped with a slot die coater. A solution having 11 wt % of ISV-BCP was prepared by dissolving an appropriate amount of the ISV-BCP in an appropriate amount of a 1,4-dioxane: acetone (70:30% w/w) solvent system. The ISV-BCP solution was then deposited onto the nylon via the slot die coater to result in a ISV-BCP solution film having a wet thickness of 4 mils (0.04 inches). The nylon was dry (that is, not pre-wetted with solvent) prior to and during deposition of ISV-BCP solution.

After an amount of time, the nylon having the ISV-BCP solution deposited thereon was plunged into a water coagulation bath to form a nylon-supported multi-layer graded ISV-BCP film. The nylon-supported multi-layer graded ISV-BCP film was then removed from the water coagulation bath and rolled using the roll-to-roll casting machine. The resulting nylon-supported multi-layer graded ISV-BCP film exhibited an external isoporous and mesoporous skin layer followed by a bulk layer, followed by a second mesoporous skin layer interfacing with the nylon support. The average pore diameters of the bulk layer increase as a function of depth from the external isoporous and mesoporous skin layer to the second mesoporous skin layer. Subsequent analysis of the ISV-BCP film may include removing the film from the nylon support to produce a free-standing ISC-BCP multi-layer graded film and analyzing the second mesoporous skin layer, which previously interfaced with the nylon support to determine if the second skin layer is also isoporous.

A disc of the nylon-supported multi-layer graded ISV-BCP film produced in this example was placed in a filter housing with the nylon support facing upward. An aqueous solution of 40 nm average particle diameter gold nanoparticles was placed in the filter housing and, with the application of positive pressure, was forced through the nylon-supported multi-layer graded ISV-BCP film. As shown in the SEM image of FIG. 31, the 40 nm AuNPs passed through the nylon support and bulk layer, and accumulated in the external isoporous and mesoporous skin layer. This indicates the average pore diameters of the second skin layer, the bulk layer, the interfacial layer between the second skin layer and the bulk layer, and the interfacial layer between the bulk layer and the external skin layer are greater than 40 nm. The AuNPs, shown as bright spots in the SEM image, are observable using energy dispersive x-ray (EDX) spectroscopy in conjunction with the SEM.

Upon comparison of FIGS. 30 and 31, it is clear that the formation of a nylon-supported multi-layer graded ISV-BCP film using a wet thickness of 4 mils results in pores in the bulk and external skin layer that are larger than the pores of the same locations of a nylon-supported multi-layer graded ISV-BCP film using a wet thickness of 3 mils. For clarity, neither FIG. 30 nor FIG. 31 show the second skin layer or the nylon support.

### Example 13—Preparation of Nylon-Supported Multi-Layer Graded ISV-BCP Film and Separation of 60 nm AuNPs

In this example, a roll of nylon (specifications disclosed above) was supported on a roll-to-roll casting machine equipped with a slot die coater. A solution having 11 wt % of ISV-BCP was prepared by dissolving an appropriate amount of the ISV-BCP in an appropriate amount of a 1,4-dioxane: acetone (70:30% w/w) solvent system. The ISV-BCP solution was then deposited onto the nylon via the slot die coater to result in a ISV-BCP solution film having a wet thickness of 4 mils (0.04 inches). The nylon was dry (that is, not pre-wetted with solvent) prior to and during deposition of ISV-BCP solution.

After an amount of time, the nylon having the ISV-BCP solution deposited thereon was plunged into a water coagulation bath to form a nylon-supported multi-layer graded ISV-BCP film. The nylon-supported multi-layer graded ISV-BCP film was then removed from the water coagulation bath and rolled using the roll-to-roll casting machine. The resulting nylon-supported multi-layer graded ISV-BCP film exhibited an external isoporous and mesoporous skin layer followed by a bulk layer, followed by a second mesoporous skin layer interfacing with the nylon support. A scanning electron microscope (SEM) image of the external isoporous and mesoporous skin layer is shown in FIG. 20. The average pore diameters of the bulk layer increase as a function of depth from the external isoporous and mesoporous skin layer to a middle portion of the bulk layer, and then decrease from the middle portion of the bulk layer to the second mesoporous skin layer. Subsequent analysis of the ISV-BCP film may include removing the film from the nylon support to produce a free-standing ISC-BCP multi-layer graded film and analyzing the second mesoporous skin layer, which previously interfaced with the nylon support to determine if the second skin layer is also isoporous.

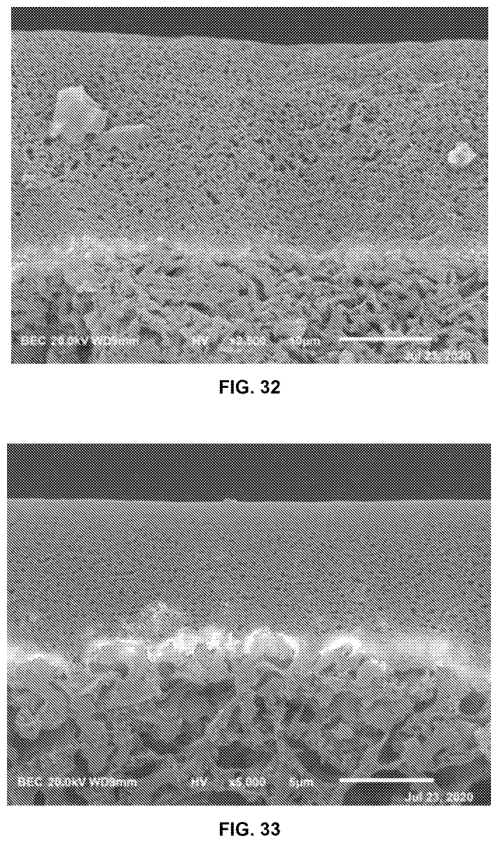

A disc of the nylon-supported multi-layer graded ISV-BCP film produced in this example was placed in a filter housing with the nylon support facing upward. An aqueous solution of 60 nm average particle diameter gold nanoparticles was placed in the filter housing and, with the application of positive pressure, was forced through the nylon-supported multi-layer graded ISV-BCP film. As shown in the SEM image of FIG. 32, the 60 nm AuNPs passed through the nylon support and accumulated in the second skin layer, and potentially the interfacial layer between the second skin layer and the bulk layer. This indicates the average pore diameter of at least the second skin layer, and potentially the average pore diameter of the interfacial layer between the second skin layer and the bulk layer, is less than or equal to 60 nm. The AuNPs, shown as bright spots in the SEM image, are observable using energy dispersive x-ray (EDX) spectroscopy in conjunction with the SEM.

### Materials and Methods—Examples 14-15.

For examples 14-15 below, a poly(isoprene-b-styrene-b-4-vinylpyridine) (ISV) block copolymer (BCP) having an overall molecular weight of approximately 222 kg/mol was synthesized by anionic polymerization. The approximate molecular weights of the poly(isoprene), poly(styrene) and poly(4-vinylpyridine) blocks were 57 kg/mol. 119 kg/mol, and 46 kg/mol respectively. A roll of nylon (3.0 μm average pore diameter, Membrane Solutions Corp., Auburn Wash.) was used as received without modification. 1,4-Dioxane (anhydrous, 99.8%, Sigma Aldrich) and acetone (HPLC grade, >99.9%, Sigma Aldrich) were used as received without further purification. 40 nm particle diameter gold nanoparticles (AuNPs; nanoComposix, San Diego, Calif.) were used as received without further purification or modification.

### Example 14—Preparation of Nylon-Supported Multi-Layer Graded ISV-BCP Film and Separation of 40 nm AuNPs

In this example, a roll of nylon (specifications disclosed above) was supported on a roll-to-roll casting machine equipped with a slot die coater. A solution having 7 wt % of ISV-BCP was prepared by dissolving an appropriate amount of the ISV-BCP in an appropriate amount of a 1,4-dioxane: acetone (70:30% w/w) solvent system. The ISV-BCP solution was then deposited onto the nylon via the slot die coater to result in a ISV-BCP solution film having a wet thickness of 3 mils (0.03 inches). The nylon was dry (that is, not pre-wetted with solvent) prior to and during deposition of ISV-BCP solution.

After an amount of time, the nylon having the ISV-BCP solution deposited thereon was plunged into a water coagulation bath to form a nylon-supported multi-layer graded ISV-BCP film. The nylon-supported multi-layer graded ISV-BCP film was then removed from the water coagulation bath and rolled using the roll-to-roll casting machine. The resulting nylon-supported multi-layer graded ISV-BCP film exhibited an external isoporous and mesoporous skin layer followed by a bulk layer, followed by a second mesoporous skin layer interfacing with the nylon support. The average pore diameters of the bulk layer appear to increase as a function of depth from the external isoporous and mesoporous skin layer to the second mesoporous skin layer. Subsequent analysis of the ISV-BCP film may include removing the film from the nylon support to produce a free-standing ISC-BCP multi-layer graded film and analyzing the second mesoporous skin layer, which previously interfaced with the nylon support to determine if the second skin layer is also isoporous.

A disc of the nylon-supported multi-layer graded ISV-BCP film produced in this example was placed in a filter housing with the nylon support facing upward. An aqueous solution of 40 nm average particle diameter gold nanoparticles was placed in the filter housing and, with the application of positive pressure, was forced through the nylon-supported multi-layer graded ISV-BCP film. As shown in the SEM image of FIG. 33, the 40 nm AuNPs passed through the nylon support and accumulated in the second skin layer, and potentially the interfacial layer between the second skin layer and the bulk layer. This indicates the average pore diameter of at least the second skin layer, and potentially the average pore diameter of the interfacial layer between the second skin layer and the bulk layer, is less than or equal to 40 nm. The AuNPs, shown as bright spots in the SEM image, are observable using energy dispersive x-ray (EDX) spectroscopy in conjunction with the SEM.

### Example 15—Preparation of Nylon-Supported Multi-Layer Graded ISV-BCP Film and Separation of 40 nm AuNPs

In this example, a roll of nylon (specifications disclosed above) was supported on a roll-to-roll casting machine equipped with a slot die coater. A solution having 7 wt % of ISV-BCP was prepared by dissolving an appropriate amount of the ISV-BCP in an appropriate amount of a 1,4-dioxane: acetone (70:30% w/w) solvent system. The ISV-BCP solution was then deposited onto the nylon via the slot die coater to result in a ISV-BCP solution film having a wet thickness of 5 mils (0.05 inches). The nylon was dry (that is, not pre-wetted with solvent) prior to and during deposition of ISV-BCP solution.

After an amount of time, the nylon having the ISV-BCP solution deposited thereon was plunged into a water coagulation bath to form a nylon-supported multi-layer graded ISV-BCP film. The nylon-supported multi-layer graded ISV-BCP film was then removed from the water coagulation bath and rolled using the roll-to-roll casting machine. The resulting nylon-supported multi-layer graded ISV-BCP film exhibited an external isoporous and mesoporous skin layer followed by a bulk layer, followed by a second mesoporous skin layer interfacing with the nylon support. The average pore diameters of the bulk layer increase as a function of depth from the external isoporous and mesoporous skin layer to the bulk layer. Subsequent analysis of the ISV-BCP film may include removing the film from the nylon support to produce a free-standing ISC-BCP multi-layer graded film and analyzing the second mesoporous skin layer, which previously interfaced with the nylon support to determine if the second skin layer is also isoporous.

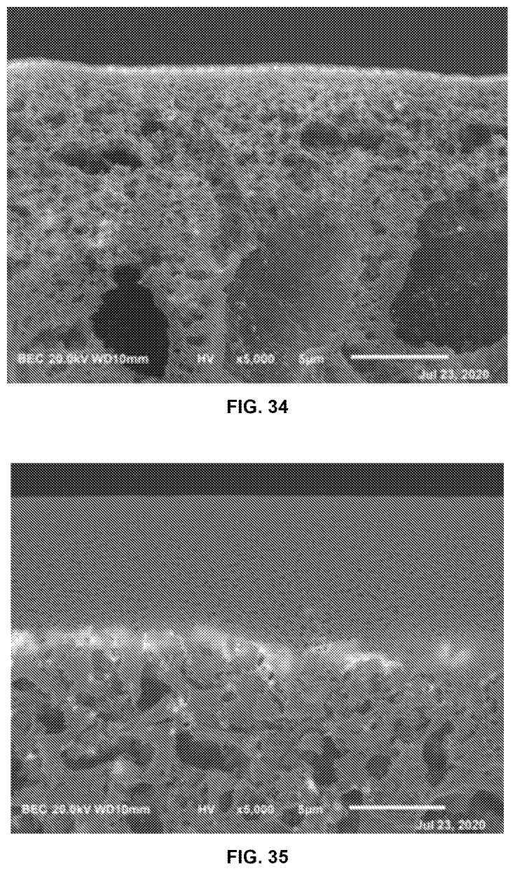

A disc of the nylon-supported multi-layer graded ISV-BCP film produced in this example was placed in a filter housing with the nylon support facing upward. An aqueous solution of 40 nm average particle diameter gold nanoparticles was placed in the filter housing and, with the application of positive pressure, was forced through the nylon-supported multi-layer graded ISV-BCP film. As shown in the SEM image of FIG. 34, the 40 nm AuNPs passed through the nylon support, the second skin layer and the bulk layer, and accumulated in the external skin layer. This indicates the average pore diameter of at least the second skin layer and the bulk layer are greater than 40 nm. The AuNPs, shown as bright spots in the SEM image, are observable using energy dispersive x-ray (EDX) spectroscopy in conjunction with the SEM.

Upon comparison of FIGS. 33 and 34, it is clear that the formation of a nylon-supported multi-layer graded ISV-BCP film using a wet thickness of 5 mils results in pores in the bulk and second skin layer that are larger than the pores in the same locations of a nylon-supported multi-layer graded ISV-BCP film using a wet thickness of 3 mils. Furthermore, as shown in FIG. 34, the use of coating with a wet thickness of 5 mils results in some super-macropores in the bulk layer. For clarity, FIG. 34 does not show the second skin layer or the nylon support.

### Materials and Methods—Examples 16-17.

For examples 16-17 below, a poly(isoprene-b-styrene-b-4-vinylpyridine) (ISV) block copolymer (BCP) having an overall molecular weight of approximately 222 kg/mol was synthesized by anionic polymerization. The approximate molecular weights of the poly(isoprene), poly(styrene) and poly(4-vinylpyridine) blocks were 57 kg/mol, 119 kg/mol, and 46 kg/mol respectively. A roll of nylon (3.0 μm average pore diameter; Membrane Solutions Corp., Auburn Wash.) was used as received without modification. 1,4-Dioxane (anhydrous, 99.8%, Sigma Aldrich) and acetone (HPLC grade, >99.9%, Sigma Aldrich) were used as received without further purification. 60 nm particle diameter gold nanoparticles (AuNPs; nanoComposix, San Diego, Calif.) were used as received without further purification or modification.

### Example 16—Preparation of Nylon-Supported Multi-Layer Graded ISV-BCP Film and Separation of 60 nm AuNPs

In this example, a roll of nylon (specifications disclosed above) was supported on a roll-to-roll casting machine equipped with a slot die coater. A solution having 7 wt % of ISV-BCP was prepared by dissolving an appropriate amount of the ISV-BCP in an appropriate amount of a 1,4-dioxane: acetone (70:30% w/w) solvent system. The ISV-BCP solution was then deposited onto the nylon via the slot die coater to result in a ISV-BCP solution film having a wet thickness of 3 mils (0.03 inches). The nylon was dry (that is, not pre-wetted with solvent) prior to and during deposition of ISV-BCP solution.

After an amount of time, the nylon having the ISV-BCP solution deposited thereon was plunged into a water coagulation bath to form a nylon-supported multi-layer graded ISV-BCP film. The nylon-supported multi-layer graded ISV-BCP film was then removed from the water coagulation bath and rolled using the roll-to-roll casting machine. The resulting nylon-supported multi-layer graded ISV-BCP film exhibited an external isoporous and mesoporous skin layer followed by a bulk layer, followed by a second mesoporous skin layer interfacing with the nylon support. The average pore diameters of the bulk layer appear to increase as a function of depth from the external isoporous and mesoporous skin layer to the second mesoporous skin layer. Subsequent analysis of the ISV-BCP film may include removing the film from the nylon support to produce a free-standing ISC-BCP multi-layer graded film and analyzing the second mesoporous skin layer, which previously interfaced with the nylon support to determine if the second skin layer is also isoporous.

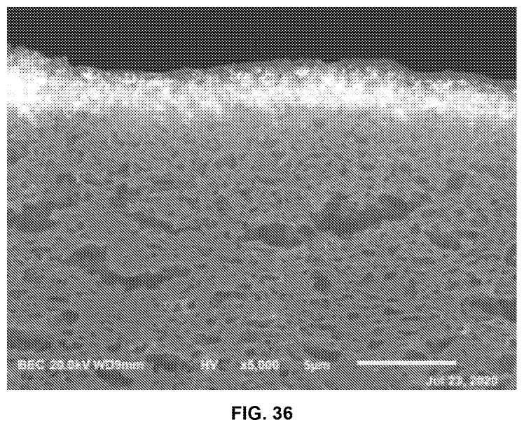

A disc of the nylon-supported multi-layer graded ISV-BCP film produced in this example was placed in a filter housing with the nylon support facing upward. An aqueous solution of 60 nm average particle diameter gold nanoparticles was placed in the filter housing and, with the application of positive pressure, was forced through the nylon-supported multi-layer graded ISV-BCP film. As shown in the SEM image of FIG. 36, the 60 nm AuNPs passed through the nylon support and accumulated in the second skin layer, and potentially the interfacial layer between the second skin layer and the bulk layer. This indicates the average pore diameter of the second skin layer, and potentially the average pore diameter of the interfacial layer between the second skin layer and the bulk layer, is less than or equal to 60 nm. The AuNPs, shown as bright spots in the SEM image, are observable using energy dispersive x-ray (EDX) spectroscopy in conjunction with the SEM.

### Example 17—Preparation of Nylon-Supported Multi-Layer Graded ISV-BCP Film and Separation of 60 nm AuNPs

In this example, a roll of nylon (specifications disclosed above) was supported on a roll-to-roll casting machine equipped with a slot die coater. A solution having 7 wt % of ISV-BCP was prepared by dissolving an appropriate amount of the ISV-BCP in an appropriate amount of a 1,4-dioxane: acetone (70:30% w/w) solvent system. The ISV-BCP solution was then deposited onto the nylon via the slot die coater to result in a ISV-BCP solution film having a wet thickness of 5 mils (0.05 inches). The nylon was dry (that is, not pre-wetted with solvent) prior to and during deposition of ISV-BCP solution.

After an amount of time, the nylon having the ISV-BCP solution deposited thereon was plunged into a water coagulation bath to form a nylon-supported multi-layer graded ISV-BCP film. The nylon-supported multi-layer graded ISV-BCP film was then removed from the water coagulation bath and rolled using the roll-to-roll casting machine. The resulting nylon-supported multi-layer graded ISV-BCP film exhibited an external isoporous and mesoporous skin layer followed by a bulk layer, followed by a second mesoporous skin layer interfacing with the nylon support. The average pore diameters of the bulk layer vary non-uniformly as a function of depth from the external isoporous and mesoporous skin layer to the second mesoporous skin layer. Subsequent analysis of the ISV-BCP film may include removing the film from the nylon support to produce a free-standing ISC-BCP multi-layer graded film and analyzing the second mesoporous skin layer, which previously interfaced with the nylon support to determine if the second skin layer is also isoporous.

A disc of the nylon-supported multi-layer graded ISV-BCP film produced in this example was placed in a filter housing with the nylon support facing upward. An aqueous solution of 60 nm average particle diameter gold nanoparticles was placed in the filter housing and, with the application of positive pressure, was forced through the nylon-supported multi-layer graded ISV-BCP film. As shown in the SEM image of FIG. 36, the 60 nm AuNPs passed through the nylon support, the second skin layer and the bulk layer, and accumulated in the external skin layer and the interfacial layer between the external skin layer and the bulk layer. This indicates the average pore diameters of the second skin layer and the bulk layer are greater than 60 nm. The AuNPs, shown as bright spots in the SEM image, are observable using energy dispersive x-ray (EDX) spectroscopy in conjunction with the SEM.

Upon comparison of FIGS. 35 and 36, it is clear that the formation of a nylon-supported multi-layer graded ISV-BCP film using a wet thickness of 5 mils results in pores in the bulk and second skin layer that are larger than the pores in the same locations of a nylon-supported multi-layer graded ISV-BCP film using a wet thickness of 3 mils. Furthermore, as shown in FIG. 36, the use of coating with a wet thickness of 5 mils results in some super-macropores in the bulk layer. For clarity, FIG. 36 does not show the second skin layer or the nylon support.

All publications, patents and patent applications cited herein are hereby incorporated by reference as if set forth in their entirety herein. While this disclosure has been described with reference to illustrative embodiments, this description is not intended to be construed in a limiting sense. Various modifications and combinations of illustrative embodiments, as well as other embodiments of the disclosure, will be apparent to persons skilled in the art upon reference to the description. It is therefore intended that the appended claims encompass such modifications and enhancements.

1. A multi-layer block copolymer material, the multi-layer block copolymer material comprising a self-assembled block copolymer;
wherein the self-assembled block copolymer comprises:
a first skin layer;
a second skin layer; and
a bulk layer disposed between the first skin layer and the second skin layer; and
wherein each of the first skin layer, the second skin layer and the bulk layer comprise pores.

2. The multi-layer block copolymer material of claim 1, wherein the self-assembled block copolymer further comprises:
a first interfacial layer disposed between the first skin layer; and/or
a second interfacial layer disposed between the second skin layer and the bulk layer.

3. The multi-layer block copolymer material of claim 1, further comprising a substrate disposed on a side of the first skin layer opposite the bulk layer.

4. The multi-layer block copolymer material of claim 3, wherein the substrate has pores; and wherein the pores have an average pore diameter ranging from about 0.1 μm to about 10 μm.

5. (canceled)

6. (canceled)

7. (canceled)

8. (canceled)

9. The multi-layer block copolymer material of claim 1, wherein the bulk layer comprises macropores, super macropores, mesopores, or a combination thereof.

10. (canceled)

11. (canceled)

12. The multi-layer block copolymer material of claim 1, wherein the first skin layer comprises micropores, mesopores, or combination thereof.

13. The multi-layer block copolymer material of claim 12, wherein the first skin layer comprises pores having a pore diameter of from about 5 nm to about 100 nm.

14. (canceled)

15. (canceled)

16. (canceled)

17. (canceled)

18. The multi-layer block copolymer material of claim 1, wherein the first skin layer is isoporous.

19. The multi-layer block copolymer material of claim 1, wherein the second skin layer comprises micropores, mesopores, or combination thereof.

20. The multi-layer block copolymer material of claim 19, wherein the second skin layer comprises pores having a pore diameter of from about 5 nm to about 50 nm.

21. (canceled)

22. (canceled)

23. (canceled)

24. (canceled)

25. (canceled)

26. (canceled)

27. (canceled)

28. The multi-layer block copolymer material of claim 1, wherein the second skin layer is isoporous.

29. The multi-layer block copolymer material of claim 1, wherein the second skin layer having average pore diameters less than an average pore diameter of the first skin layer.

30. (canceled)

31. (canceled)

32. (canceled)

33. (canceled)

34. (canceled)

35. (canceled)

36. (canceled)

37. (canceled)

38. (canceled)

39. The multi-layer block copolymer material of claim 1, wherein the second skin layer having average pore diameters less than an average pore diameter of phase inverted pores of the bulk layer.

40. (canceled)

41. (canceled)

42. (canceled)

43. (canceled)

44. (canceled)

45. (canceled)

46. (canceled)

47. The multi-layer block copolymer material of claim 1, further comprising nanoparticles disposed within the pores of the first skin layer, the second skin layer, or a combination thereof.

48. (canceled)

49. (canceled)

50. (canceled)

51. (canceled)

52. (canceled)

53. (canceled)

54. A filtration device comprising a multi-layer block copolymer material according to claim 1.

55. (canceled)

56. (canceled)

57. (canceled)

58. (canceled)

59. (canceled)

60. (canceled)

61. A method of filtration, wherein the method comprises providing a sample to the filtration device of claim 54 via inlet to the filtration device; and collecting a filtrate material that has pass through the filtration device.

62. (canceled)

63. (canceled)

64. (canceled)

65. (canceled)

66. (canceled)

67. (canceled)

68. (canceled)

69. (canceled)

70. The method of claim 61, wherein the sample comprises a feedstream.

71. The method of claim 70, wherein the feedstream is a feedstream from a bioreactor.

72. (canceled)

73. A method to prepare the multi-layer block copolymer material gf claim 1, the method comprising the steps of:
(a) providing a deposition solution comprising at least one multiblock copolymer and a solvent system;
(b) depositing the deposition solution on a substrate to form an initial film;
(c) removing a portion of a solvent of the solvent system from the initial film to form a partial solvent removed initial film; and
(d) contacting the partial solvent removed initial film with a phase separation solvent system, thereby forming the multi-layer block copolymer material;
wherein the substrate has pores; and wherein the pores have an average pore diameter ranging from about 0.1 μm to about 10 μm.

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. A multi-layer block copolymer material made by the method of claim 73.
